(19) United States
(12) Patent Application Publication
(10) Pub. No.: US 2008/0288407 A1
(43) Pub. Date: Nov. 20, 2008

(54) METHOD, SYSTEM AND COMPUTER PROGRAM PRODUCT FOR DETECTING AND PREVENTING FRAUDULENT HEALTH CARE CLAIMS

(75) Inventors: Jay A. Hamel, Troy, NY (US); Joseph Michael Werner, West Springfield, MA (US)

Correspondence Address: SCHMEISER, OLSEN & WATTS, 22 CENTURY HILL DRIVE, SUITE 302, LATHAM, NY, 12110, US

(73) Assignee: MEDICAL MANAGEMENT TECHNOLOGY GROUP, INC., Troy, NY (US)

(21) Appl. No.: 12/119,879

(22) Filed: May 13, 2008

Related U.S. Application Data
(60) Provisional application No. 60/938,322, filed on May 16, 2007.

(51) Int. Cl. G06Q 50/00; G06F 7/04; G06F 17/30; G06F 15/16

(52) U.S. Cl. 705/50; 707/6; 709/201; 382/187; 707/E17.017; 707/E17.019

(57) ABSTRACT

A method and system for detecting and preventing fraudulent health care claims. A bar code having a service date and provider ID is generated. The provider ID identifies a health care service provider that is requested to provide a service to a client on the service date. A digital image file that includes the bar code, transaction data, and a signature is received. The signature, transaction data, provider ID and service date are extracted from the digital image file. Verification software determines whether the extracted signature matches the client's reference signature stored in a database. Verification software determines whether extracted data that includes service date, provider ID, and client ID is included in any transaction record in the database. A report is generated that identifies a fraudulent claim if the extracted signature does not match any reference signature or if the extracted data is not included in any transaction record.

### CROSS REFERENCE TO RELATED APPLICATION

This application hereby claims the benefit of U.S. Provisional Application No. 60/938,322 filed May 16, 2007, the contents of which are hereby incorporated herein by reference in their entirety.

### FIELD OF THE INVENTION

The present invention relates generally to a data processing method and system for managing health care transactions, and more particularly to an image analysis technique that processes data from digitized signatures and bar codes to detect and prevent fraudulent health care claims.

### BACKGROUND OF THE INVENTION

The United States spends more than $2 trillion on health care every year. Of that amount, the National Health Care Anti-Fraud Association estimates that more than $60 billion each year is lost to health care fraud. Health care fraud is any misrepresentation of a material fact submitted on, or in support of a claim for payment of a health care insurance claim. A claim for payment based on the aforementioned misrepresentation is referred to herein as a fraudulent health care claim. Fraudulent health care claims include, for example, a claim for a health care service or product that is never delivered (i.e., phantom billing), a claim that uses a billing code for a higher level of service when a lower level of service was actually rendered (i.e., upcoding), and a claim based on authorization deficiencies (e.g., a claim for an unauthorized service or a service that was authorized for a different location and/or a different date). Conventional methods and systems for preventing health care fraud include a verification that a person was at a particular location at a particular time (e.g., a patient was at a doctor's office on a specified date), which fails to identify fraudulent health care claims based on the aforementioned authorization deficiencies. Thus, there exists a need to detect and prevent fraudulent health care claims and to overcome at least one of the preceding deficiencies and limitations of the related art.

### SUMMARY OF THE INVENTION

In first embodiments, the present invention provides a computer-implemented method for detecting and preventing fraudulent health care claims. A health care claim verification computing unit (first computing unit) generates an encrypted bar code that includes a set of bar code data that identifies a health care transaction. The bar code data includes a service date and a provider ID that identifies a health care service provider that provides a health care service to a client on the service date. Subsequent to generating the bar code, the first computing unit receives a digital image file that includes the bar code, a set of transaction data that describes the transaction, and a signature that is initially handwritten by the client. Subsequent to receiving the digital image file, (1) the first computing unit extracts the set of transaction data and the signature from the digital image file and (2) the first computing unit extracts the provider ID and the service date from the bar code included in the digital image file. Subsequent to extracting the set of transaction data and the signature, the first computing unit determines that the extracted signature matches a reference signature that is stored in a database that associates the reference signature with the client. A group of extracted data is determined to be not included in any transaction record in the database. The transaction records are stored in the database prior to generating the bar code. The group of extracted data includes the extracted service date, the extracted provider ID, and an identifier of the client. The identifier of the client is included in the extracted set of transaction data. In response to determining that the group of extracted data is not included in any transaction record, the first computing unit generates a report that identifies a fraudulent health care claim that indicates a billing for the service that is provided by the provider to the client on the service date, but that is not authorized by a payer entity via a transaction record being included in the database.

A system and computer program product corresponding to the above-summarized method are also described and claimed herein.

In second embodiments, the present invention provides a computer-implemented method of detecting a fraudulent health care claim for a payment for a health care service. A first computing unit controlled by a health care claim verification entity (CVE) generates an encrypted bar code that includes a set of bar code data that identifies a set of health care transactions. The bar code data includes a service date and a provider ID that identifies a health care service provider that is requested to provide a set of health care services to a set of clients on the service date. The set of transactions includes a transaction that indicates that the provider is requested to provide, on the service date, a health care service included in the set of health care services to a client included in the set of clients. Subsequent to generating the bar code, the first computing unit stores the bar code in a computer data file. Subsequent to storing the bar code, the first computing unit posts the computer data file to a website controlled by the CVE and accessible by a second computing unit controlled by the provider. The computer data file is sent to the second computing unit via an access of the website by the second computing unit. Subsequent to sending the computer data file, the second computing unit prints a transaction document that includes the bar code and a set of data entry areas for receiving a set of transaction data that describes the transaction. Subsequent to the printing step, the first computing unit receives a digital image file that includes the bar code data, the set of transaction data received in the set of data entry areas and a signature that indicates the client. Subsequent to receiving the digital image file, the first computing unit extracts the bar code data, the signature, and the set of transaction data from the digital image file. Subsequent to the extracting step, a signature verification engine executing on the first computing unit determines a score that indicates whether the extracted signature matches a reference signature that is stored in a database residing in a computer data storage unit. The database associates the reference signature with the client. If the score does not satisfy a set of predefined criteria for matching the extracted signature to the reference signature, the first computing unit generates a first report that includes a first type of fraudulent health care claim. The first type indicates a billing for the service by the provider, but the service is not provided to the client by the provider. Subsequent to the extracting step, the first computing unit searches the database for a match between a group of extracted data and a transaction record of a set of transaction records stored in the database prior to the step of generating the bar code. The group of extracted data includes the extracted set of transaction data and the extracted bar code data. The match includes an identifier of the client included in the extracted set of transaction data matching a client identifier in the transaction record, the extracted service date included in the extracted bar code data matching a date in the transaction record, and the extracted provider ID included in the extracted bar code data matching a provider identifier in the transaction record. In response to the searching step, the match is identified as being absent. In response to identifying the match as being absent, the first computing unit generates a second report that includes a second type of fraudulent health care claim. The second type indicates a billing for the service, but the service provided by the provider to the client on the service date is not authorized by any transaction record of the set of transaction records.

In third embodiments, the present invention provides a computer-implemented method of verifying a claim for a payment for a health care service. A first computing unit controlled by a health care claim verification entity generates an encrypted bar code that includes a set of bar code data that identifies a health care transaction. The set of bar code data includes a service date and a provider ID that identifies a health care service provider that provides a health care service to a client on the service date. Subsequent to generating the bar code, the first computing unit receives a digital image file that includes the bar code, a set of transaction data that describes the transaction, and a signature that is initially handwritten by the client. Subsequent to receiving the digital image file, the first computing unit extracts the set of transaction data and the signature from the digital image file. Subsequent to receiving the digital image file, the first computing unit extracts the provider ID and the service date from the bar code included in the digital image file. Subsequent to extracting the set of transaction data and the signature, the first computing unit determines that the extracted signature matches a reference signature that is stored in a database that associates the reference signature with the client. A group of extracted data is determined to be included in a transaction record of a set of transaction records stored in the database prior to generating the bar code. The group of extracted data includes the extracted service date, the extracted provider ID, and an identifier of the client. The identifier of the client is included in the extracted set of transaction data. In response to determining that the group of extracted data is included in the transaction record and determining that the extracted signature matches the reference signature, the first computing unit generates a report that verifies a claim for a payment of the service.

Advantageously, the present invention provides a technique for detecting and preventing fraudulent health care claims for any type of health care transaction that uses a bar code having health care transaction data to facilitate matching transaction data extracted from the bar code to stored transaction data and that further uses signature verification as proof of a service or product being provided (e.g., claims relative to non-emergency medical transportation, home health care, a physician's office visit, filling a prescription at a pharmacy, etc.).

### BRIEF DESCRIPTION OF THE DRAWINGS

FIG. 1 is a block diagram of a system for detecting and preventing fraudulent health care claims, in accordance with embodiments of the present invention.

FIG. 2 is a block diagram of a signature verification and encrypted bar code system that includes the signature verification engine of the system of FIG. 1, in accordance with embodiments of the present invention.

FIGS. 3A-3C depict a flow diagram of a computer-implemented process for detecting and preventing fraudulent health care claims in the system of FIG. 1, in accordance with embodiments of the present invention.

FIG. 3D is a flow diagram of a computer-implemented process for verifying a signature in the system of FIG. 2, in accordance with embodiments of the present invention.

FIGS. 4A-4C depict a flow diagram of a computer-implemented process for detecting a fraudulent health care claim associated with non-emergency medical transportation, in accordance with embodiments of the present invention.

FIGS. 5A-5C depict a flow diagram of a computer-implemented process for detecting a fraudulent health care claim associated with filling a prescription at a pharmacy, in accordance with embodiments of the present invention.

FIGS. 6A-6C depict a flow diagram of a computer-implemented process for detecting a fraudulent health care claim associated with a visit to a physician's office, in accordance with embodiments of the present invention.

FIG. 7 is a block diagram of a computing system that implements the process of FIGS. 3A-3C, in accordance with embodiments of the present invention.

### DETAILED DESCRIPTION OF THE INVENTION

### Overview

The present invention provides a system, method and computer program product that generates encrypted health care transaction information in a bar code format, captures a client's signature specifically correlated to and inseparable from the bar code, and integrates a signature verification method with an exception reporting software module, thereby facilitating the detection and prevention of fraudulent claims for health care services and products. The technique disclosed herein combines the bar code and a verified client signature to associate the client with a particular place, date and time and to associate the presence of the client with a particular health care transaction being performed on that date (e.g., the provision of non-emergency medical transportation). Thus, the system and method disclosed herein use the bar code and verified signature to relate the health care transaction time and location to a particular claim.

In one embodiment, a client's signature on a form (e.g., a paper form) is correlated with transaction data displayed on the form, thereby signifying the acceptance and agreement of the client, and further the client's signature is correlated with the transaction information included in the encrypted bar code in a manner compliant with privacy regulations relevant to health information (e.g., Health Insurance Portability and Accountability Act (HIPAA) of 1996), which prevents anyone from duplicating the use of the signature.

In another embodiment, a health care provider (a.k.a. health care service provider) (e.g., a pharmacy) notifies a claims verification service provider (CVSP) (a.k.a. claim verification entity or CVE) of a request for a health care service (e.g., a request to have a prescription filled). The CVSP generates the encrypted bar code in the form of a label or form which is electronically transmitted to the health care provider via a website that complies with health information privacy regulations (e.g., HIPAA regulations). The health care provider prints the label or form which is presented to the client (e.g., presented to the client together with the filled prescription). The bar code is scanned with a bar code scanner and the client provides a signature on a digitizer pad. The information from the scan of the bar code and the digital signature provided via the digitizer pad are correlated in the same data file and are associated throughout the fraud detection process described herein.

As used herein, “scan” and its variants (e.g., “scanned”) is defined as the process of analyzing and digitally encoding (i.e., digitizing) text, graphics and/or bar code patterns included on a physical object (e.g., a printed document, printed form or analog image) to create a digital image (e.g., bitmapped image) represented as binary data for storage in a computer file format and/or for processing by a computing device.

As used herein, “health care transaction” or “transaction” is defined as an act of providing or selling a health care service or product to a client.

### Fraud Detection and Prevention System

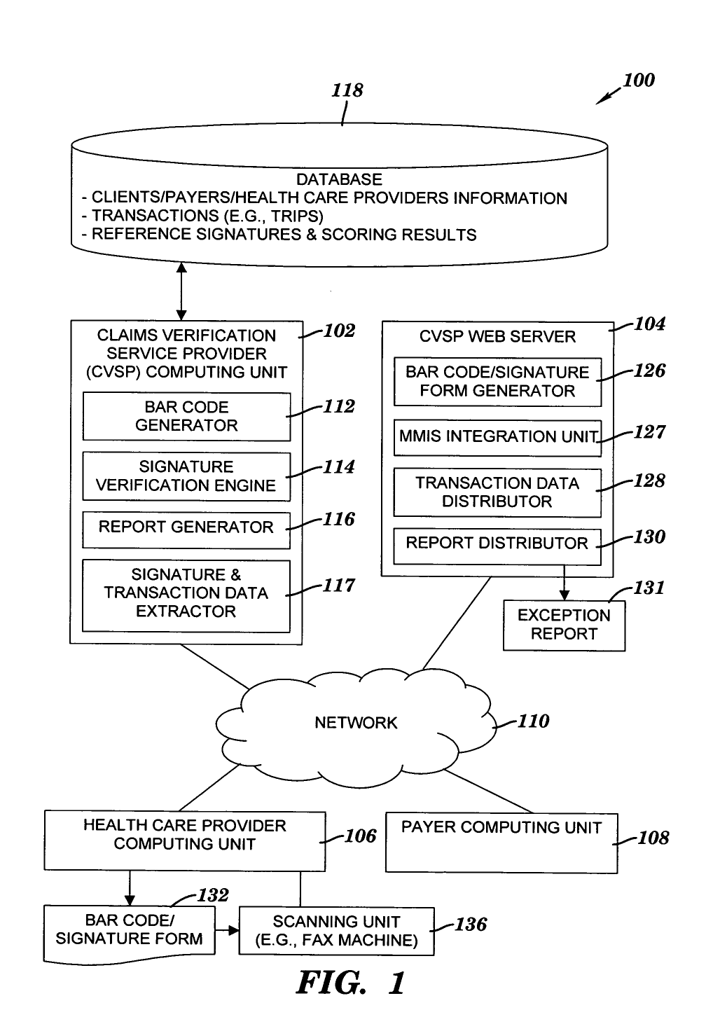

FIG. 1 is a block diagram of a system for detecting and preventing fraudulent health care claims, in accordance with embodiments of the present invention. System 100 includes a claims verification service provider (CVSP) computing unit 102, a CVSP web server 104, a health care provider computing unit 106 and a payer computing unit 108. The descriptive name of each of computing units 102, 106 and 108 indicates the entity that utilizes and controls (i.e., manages) the computing unit. For example, CVSP computing unit 102 is utilized and controlled by a claims verification service provider (a.k.a. claim verification entity or CVE), health care provider computing unit 106 is utilized and controlled by a health care provider, and payer computing unit 108 is utilized and controlled by a payer entity (e.g., an insurer). Similarly, CVSP web server 104 is a web server utilized and controlled by the claims verification service provider. The claims verification service provider, health care provider and payer entity are separate and different entities.

In another embodiment, CVSP web server 104 is a web server that is utilized by the claims verification service provider and managed by a third party (not shown in FIG. 1) that is different from the claims verification service provider, the health care provider and the payer entity. Computing units 102, 106 and 108 access a website (also referred to herein as the CVSP website) provided by CVSP web server 104 via a network 110 (e.g., the Internet).

CVSP computing unit 102 includes a bar code generator 112, a signature verification engine (SVE) 114, a report generator 116, and a signature & transaction data extractor 117. CVSP computing unit 102 is coupled to one or more storage units that include a claims verification database 118. Database 118 includes, for example, relational database tables that store information about clients, health care service providers (e.g., non-emergency medical transportation providers), payers (e.g., insurers), transactions (e.g., non-emergency medical transportation trips), reference signatures and results of scoring signatures. Data that determines whether a client is eligible to receive a payment from a payer for a health care service is also stored in database 118.

Bar code generator 112 generates encrypted bar codes that include transaction data (i.e., data related to a health care transaction). Transaction data includes the following information: date and time of the health care transaction, a name of a client who is receiving a health care product or service, the client's identification code (e.g., Medicaid Client Identification Number (CIN)), and details of the health care product or service being provided.

SVE 114 receives digital signatures (e.g., handwritten signatures on paper-based forms that have been faxed or scanned, or signatures provided on an electronic touch pad) and associated bar codes that include transaction data, decodes the bar codes, stores the transaction data decoded from the bar codes in database 118, and compares received signatures to one or more reference signatures stored in database 118 to detect fraudulent health care claims.

Report generator 116 generates one or more exception reports that identify health care claims as fraudulent and/or potentially fraudulent based on predefined criteria.

Signature & transaction data extractor 117 extracts transaction data, bar code data and signatures from a transaction document that is described below.

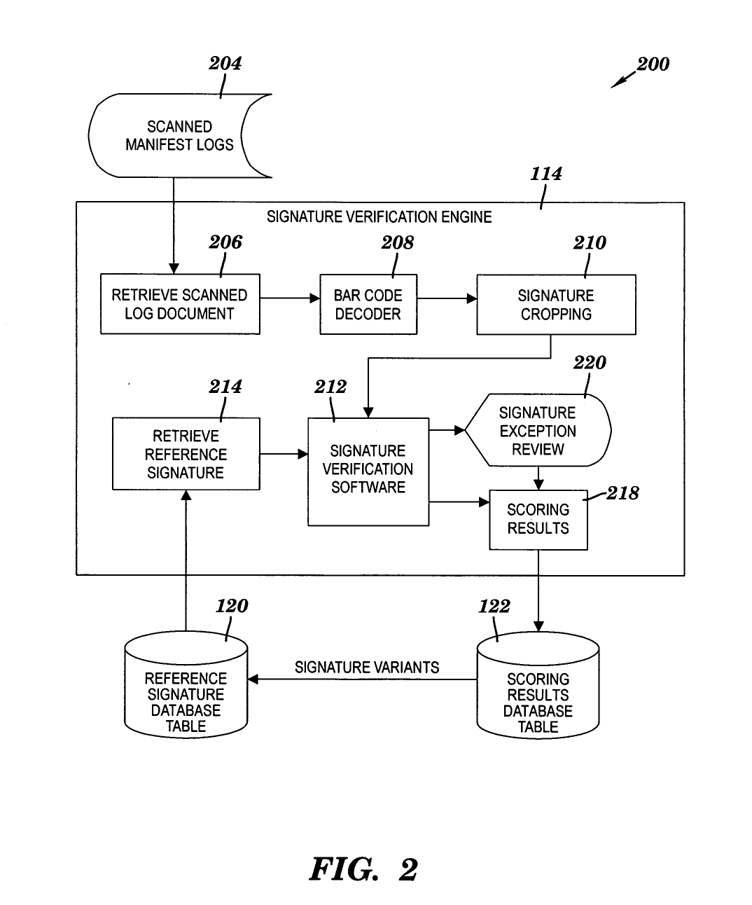

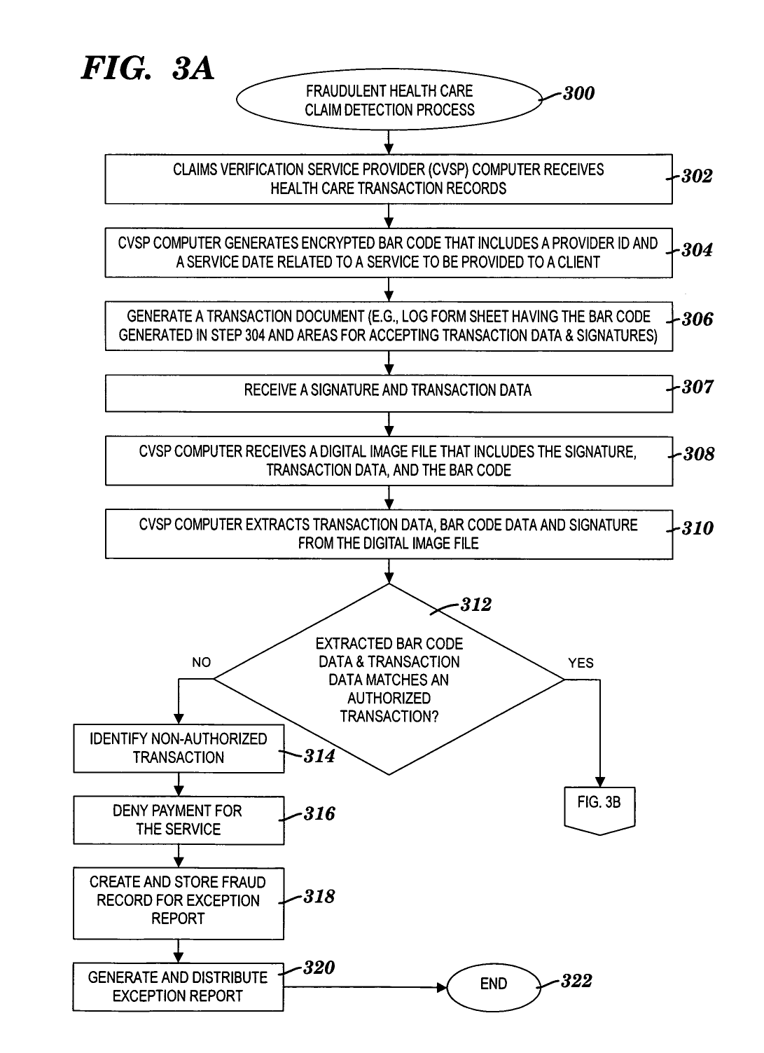

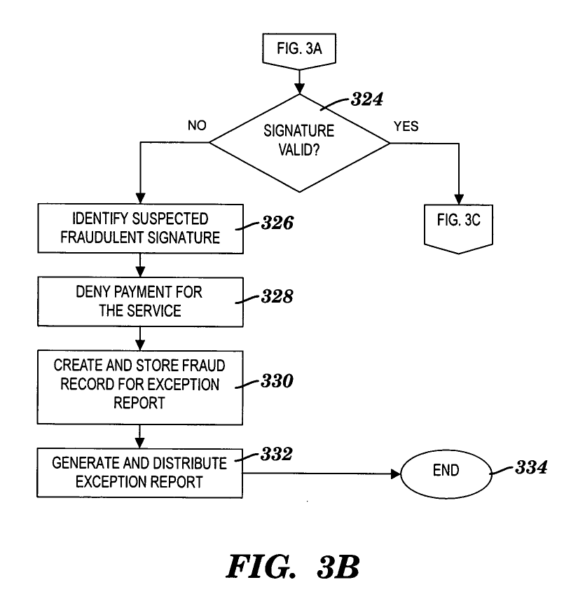

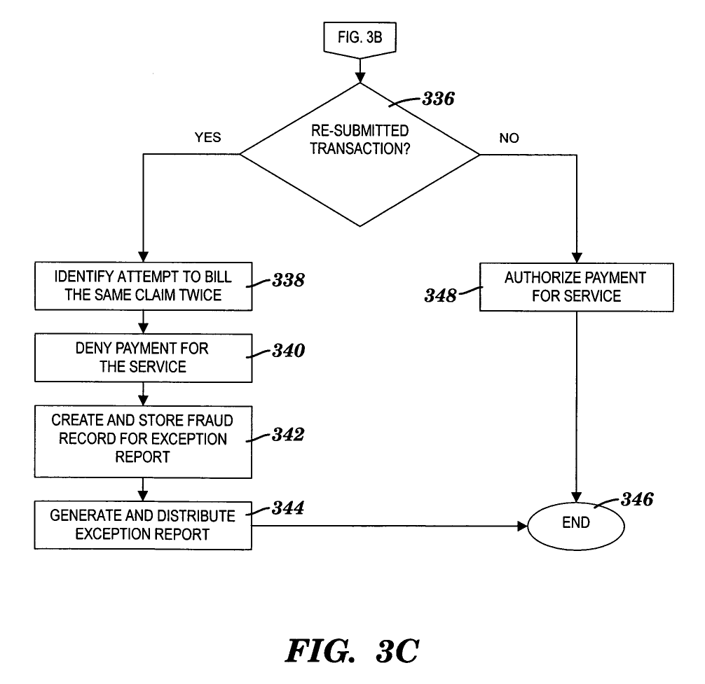

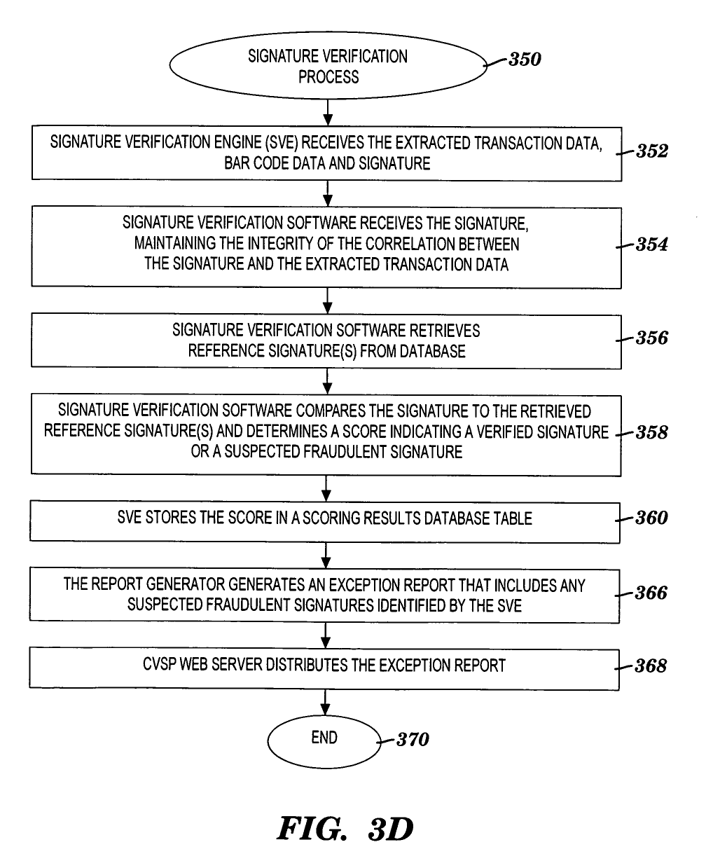

Components of system 100 that are included in or coupled to CVSP computing unit 102 are described in detail in the claims verification process presented below relative to FIGS. 3A-3C. Subcomponents of SVE 114 are described below relative to FIG. 2.

CVSP web server 104 includes a bar code/signature form generator 126 that allows a computing unit (e.g., health care provider computing unit 106) that accesses the CVSP website to generate (e.g., print) a physical form (e.g., non-emergency medical transportation log sheet or pharmacy prescription label) that includes bar code(s) generated by bar code generator 112 and optionally also includes area(s) for accepting one or more handwritten signatures from one or more clients who are receiving the health care product or service.

In one embodiment, CVSP web server 104 includes a software-based Medicaid Management Information System (MMIS) integration unit 127 that generates either prior authorization/approval requests or payment requests based on approved transactions.

CVSP web server 104 also includes a transaction data distributor 128 and a report distributor 130. Transaction data distributor 128 distributes transaction data to health care provider computing unit 106. Report distributor distributes an exception report 131 that indicates fraudulent and/or potentially fraudulent health care claims. Exception report 131 is distributed to payer computing unit 108 and/or health care provider computing unit 106. Exception report 131 may also be accessed for internal use by CVSP computing unit 102.

The functionality of the components of CVSP web server are described in more detail relative to the claims verification process presented below relative to FIGS. 3A-3C.

Health care provider computing unit 106 produces (e.g., prints) a form 132 (a.k.a., transaction document or bar code/signature form) that includes (1) bar code(s) without any signature areas, (2) a bar code associated with one or more signature areas or (3) bar code(s) and area(s) for signature(s), where each area for a signature is associated with one or more bar codes. Form 132 is, for example, a paper-based form, such as a log form printed on a sheet of paper. Form 132 includes one or more data entry areas for accepting transaction data. In one embodiment, the one or more data entry areas include a designated area for receiving a handwritten entry of a client's name or a portion of the client's name. In another embodiment, the one or more data entry areas include optical mark recognition (OMR) areas for receiving handwritten marks (e.g. penciled tick marks), to indicate an identification of a client, such as a portion (e.g., last four digits) of the client's home phone number. In still another embodiment, data entry areas of form 132 receive an identification of a client (e.g., the client's name) receiving non-emergency medical transportation, a pickup time, a drop-off time, an identification of a driver of a vehicle providing the client's transportation and an identification of the vehicle, and the information in these data entry areas is recognized by an optical character recognition (OCR) tool. For example, the data entry areas may be “OCR fields” designed to look like liquid crystal display (LCD) digits

In one embodiment, each form is one sheet of paper and each sheet includes exactly one bar code that is unique to the sheet that includes the bar code. In another embodiment, each form includes multiple bar codes, where each bar code on a form is associated with a corresponding transaction area, and each transaction area on the form includes areas for receiving a client's signature and transaction data (e.g., information about a non-emergency medical transportation trip).

After the signature and data entry areas on form 132 are completed, a representative of the health care provider scans form 132 using a scanning unit 136. In one embodiment, scanning unit 136 is a fax machine that faxes a paper-based form 132 to CVSP computing unit 102, where extractor 117 extracts bar code data, transaction data, and signature(s) from the bar code, data entry area(s), and signature area(s), respectively, that are included in form 132.

The functionality of signature & transaction data extractor 117 and scanning unit 136 is described in more detail in the claims verification process presented below relative to FIGS. 3A-3C.

FIG. 2 is a block diagram of a signature verification and encrypted bar code system 200 that includes the signature verification engine of the system of FIG. 1, in accordance with embodiments of the present invention. System 200 includes one embodiment of SVE 114, a reference signature database table 120 and a scoring results database table 122. Input to SVE 114 includes scanned manifest logs 204 (e.g., non-emergency medical transportation log sheets each having bar codes and signatures, where the signatures are associated with the bar codes in a one-to-one correspondence). In step 206, SVE 114 retrieves a scanned log document from scanned manifest logs 204. SVE 114 includes bar code decoder 208 that decodes one or more bar codes included in the retrieved scanned log document. The decoding provided by bar code decoder 208 extracts transaction data and/or other data associated with a particular bar code. The extracted data facilitates a matching of the extracted data with a transaction already stored in database 118 (see FIG. 1). Furthermore, the extracted data is stored in database 118 (see FIG. 1). Signature cropping module 210 identifies each area (a.k.a. signature area) of the retrieved scanned log document that includes a signature and a signature verification software application 212 accesses each signature in the identified area(s). In step 214, for each accessed signature, one or more reference signatures are retrieved from reference signature database table 120. Signature verification software 212 compares each accessed signature to the accessed signature's one or more retrieved reference signatures and determines a scoring result 218 that indicates whether or not the accessed signature matches any of the one or more retrieved reference signatures. If the accessed signature fails to match any retrieved reference signature, the accessed signature is invalid (i.e., not approved). For example, the accessed signature is invalid if the scoring result 218 is less than a predefined minimum acceptable score. If the accessed signature matches any retrieved reference signature, the accessed signature is valid (i.e., approved). For example, the accessed signature is valid if the scoring result 218 is greater than or equal to a predefined minimum acceptable score. If the accessed signature is invalid, signature verification software 212 provides (e.g., displays) a signature exception report 220 for review by the claims verification service provider or another fraud-detecting entity to determine if the invalid signature indicates a fraudulent health care claim. In one embodiment, the review of the exception report 220 modifies the signature's invalid status. For example, an operator reviewing exception report 220 utilizes a source external to signature verification engine 114 to determine that the accessed signature is valid even though the initial scoring result 218 indicates that the signature is invalid. In this example, the signature's status is changed from invalid to valid to reflect the operator's determination that the signature is valid. Scoring results 218 are stored in scoring results database table 122 in, for example, an Extensible Markup Language (XML) format. Signature variants indicated by the scoring results stored in database table 122 are used to update reference signature database table 120. In one embodiment, database tables 120 and 122 are relational database tables included in database 118 (see FIG. 1). In one embodiment, database table 122 includes other transaction data in addition to the scoring results.

Signature verification software 212 is, for example, SignWare® offered by Softpro GmbH located in Boeblingen, Germany.

### Detecting and Preventing Fraudulent Health Care Claims

FIGS. 3A-3C depict a flow diagram of a computer-implemented process for detecting and preventing fraudulent health care claims in the system of FIG. 1, in accordance with embodiments of the present invention. The fraudulent health care claim detection and prevention process begins at step 300 of FIG. 3A. In step 302, CVSP computing unit 102 (see FIG. 1) receives a set of health care transaction records (a.k.a. set of transaction records) that include information regarding health care services that are requested to be provided by multiple health care providers to multiple clients, and may further include information regarding health care products that are to be sold by multiple health care providers to multiple clients. Step 302 includes the CVSP computing unit 102 (see FIG. 1) receiving a transaction record that describes a requested health care transaction in which a client is to be provided a health care service or sold a health care product by a health care provider. Hereinafter, the health care transaction described by the transaction record received in step 302 is also referred to simply as “the transaction.”

In step 304, bar code generator 112 (see FIG. 1) generates an encrypted bar code (e.g., a 2-D PDF417 bar code) that includes information (a.k.a. bar code data) relevant to the health care service or product being provided or sold to the client. The bar code data includes, for example, the date of the transaction, the time of the transaction, and one or more details of the service or product to be provided or sold. In an embodiment in which the transaction is filling a prescription, the details of the service include prescription number, drug name and quantity. In another embodiment in which the transaction is providing non-emergency medical transportation, the details of the service include, for example, a date that the transportation service is to be provided and an identification of the transportation provider. In still another embodiment in which the transaction is providing non-emergency medical transportation and CVSP computing unit 102 (see FIG. 1) has received and stored the health care provider's routes, form 132 (see FIG. 1) is a pre-filled form that includes a bar code. Each client name is pre-printed on the pre-filled form in an area associated with (e.g., next to) an area that receives the corresponding client's signature. The bar code included on the pre-filled form stores trip identifiers, where each signature on the form corresponds to one of the stored trip identifiers.

In the case of the transaction providing non-emergency medical transportation, the bar code may also include an identification of the service to be provided (e.g., take trip or a return trip). In still another embodiment in which the transaction is providing home health care, the details of the service include, for example, an indication of whether the client needs assistance with medication.

In one embodiment, the encrypted bar code contains a representation of a unique identifier of a log form sheet that displays the bar code. The unique code is used to detect a re-submission of a claim for a payment for a health care service (e.g., a re-submission of a single log form sheet by faxing the same sheet twice). The unique code is described in more detail below relative to the discussion of step 336.

In one embodiment, the encrypted bar code generated in step 304 protects the privacy of the client's health information according to governmental regulations. For example, the client's health information is encrypted in the bar code in a HIPAA-compliant manner. In another embodiment, the encrypted bar code prevents disclosure of the client's Medicaid CIN or other client identification information. In still another embodiment, embedded in the encrypted bar code are the transaction date, an identification of the transaction and client-specific information that can be accessed only via looking up data in database 118 (see FIG. 1), thereby preventing the reuse of the bar code for more than one transaction or for a substitute transaction.

In step 306, CVSP computing unit 102 (see FIG. 1) transmits the encrypted bar code to health care provider computing unit 106 (see FIG. 1) via network 110 (see FIG. 1) (e.g., via a website provided by CVSP web server 104 of FIG. 1), along with other information needed to generate a paper-based transaction document that includes the bar code and data entry areas for receiving handwritten transaction data. Also in step 306, health care provider computing unit 106 (see FIG. 1) generates a paper-based transaction document (i.e., bar code/signature form 132 of FIG. 1) that includes the bar code and data entry areas for receiving handwritten transaction data.

In one embodiment, the transaction document includes multiple sets of data entry areas for receiving handwritten transaction data, multiple signature areas (one signature area for each set of data entry areas) for accepting signatures handwritten by multiple clients, and a single encrypted bar code. The encrypted bar code includes an identification of the health care provider that is requested to provide a service to the client and the date (i.e., service date) the health care service is to be provided to the client by the health care provider. In one example, the transaction document is a log form sheet that includes areas for receiving client signatures and for recording transaction data (e.g., type of trip, pickup time, drop-off time, etc.) related to non-emergency medical transportation.

In another embodiment, the transaction document includes multiple sets of data entry areas, multiple signature areas and multiple bar codes, where the bar codes, signature areas and sets of data entry areas are associated in a one-to-one-to-one correspondence.

In still another embodiment, the transaction document is a form or label having an encrypted bar code corresponding to a biometric signature provided by the client.

In step 307, the client's handwritten signature is received. In one embodiment, the client writes her/his signature in a signature area on a log form sheet that is generated as the transaction document in step 306. In another embodiment, the client writes her/his signature on a digital pen pad device (a.k.a. graphics tablet, digitizer tablet or pen tablet). Although subsequent steps of the fraudulent health care claim detection process describe verification actions taken on a single signature, the present invention contemplates receiving multiple signatures from multiple clients in step 307 and applying the verification process to each of the multiple signatures. Also in step 307, transaction data is received on the transaction document generated in step 306. In one embodiment, data related to the transaction is handwritten in the data entry areas included in the transaction document generated in step 306. For example, a driver providing non-emergency medical transportation writes the client's name (or a portion of the client's name), the type of transportation (e.g., return trip), the pick-up time and the drop-off time in designated data entry areas on the transaction document generated in step 306.

Following step 307, the health care provider or a designated delegate of the health care provider sends the transaction document (e.g., log form sheet) to CVSP computing unit 102 (see FIG. 1), where the transaction document is received as a digital image file that includes the signature received in step 307, the transaction data received in step 307 and the bar code generated in step 304. In one embodiment, the health care provider or designated delegate thereof uses fax machine 136 (see FIG. 1) to fax the completed transaction document to an automatic fax system coupled to CVSP computing unit 102 (see FIG. 1). The automatic fax system receives the fax and generates a digital image file of the faxed transaction document. The digital image file is in a computer file format. In one embodiment, the computer file format of the digital image file is Portable Document Format (PDF).

In another embodiment, the health care provider or designated delegate thereof uses scanning unit 136 (see FIG. 1) to scan the completed transaction document to a digital image file (e.g., a TIFF file) that is identified with a date/time stamp. The health care provider computing unit 106 (see FIG. 1) stores the digital image file in a computer file system.

In step 308, CVSP computing unit 102 (see FIG. 1) receives the digital image file that includes the signature received in step 307, the transaction data received in step 307 and the bar code generated in step 304. Following step 308, CVSP computing unit 102 (see FIG. 1) stores the received digital image file in a computer file system (e.g., database 118 of FIG. 1).

In step 310, signature & transaction data extractor 117 (see FIG. 1) extracts the transaction data, the bar code data and the signature from the digital image file. In one embodiment, portions of the digital image file are stored as separate records in database 118 (see FIG. 1). For example, if the digital image file is a PDF file, a first portion of the PDF file corresponding to one side of the log sheet that includes the transaction data is stored in a first record of database 118 (see FIG. 1) and a second portion of the PDF file corresponding to the other side of the log sheet that includes signature data is stored in a second record of database 118 (see FIG. 1).

In one embodiment, if the transaction data is extracted by CVSP computing unit 102 (see FIG. 1), then computing unit 102 (see FIG. 1) stores and correlates the extracted transaction data, the extracted signature, the provider ID extracted from the bar code data, and the service date extracted from the bar code data in database 118 (see FIG. 1). In one embodiment, computing unit 102 (see FIG. 1) also uploads the extracted transaction data, extracted signature, extracted provider ID, and extracted service date to the CVSP website provided by CVSP web server 104 (see FIG. 1). In another embodiment, if the transaction data, signature and bar code data is extracted by health care provider computing unit 106 (see FIG. 1), then computing unit 106 (see FIG. 1) uploads the extracted transaction data, signature and bar code data to the CVSP website provided by CVSP web server 104 (see FIG. 1).

As one example, consider a request for non-emergency medical transportation from a Mary Smith in a case where there are several hundred Mary Smiths who receive Medicaid in New York State. Scanning and reading the encrypted bar code and maintaining the correlation with a particular signature provides assurance that the Mary Smith who provided the signature in step 307 is the Mary Smith who is authorized to receive the requested non-emergency medical transportation to a particular place on a particular date, and from a particular health care provider.

Inquiry step 312 determines whether the extracted bar code data and the extracted transaction data match an authorized transaction (i.e., match a transaction record of the set of transaction records received in step 302. In a first embodiment, step 312 is automatically performed by the SVE 114 (see FIG. 1) in CVSP computing unit 102 (see FIG. 1). In the first embodiment described in this paragraph, the extracted transaction data includes an identification of the client, such as the client's name, a portion of the client's name, the client's home phone number or a portion (e.g., the last four digits) of the client's home phone number. As a first example, the last four digits of the client's home phone number were previously encoded in OMR areas that are included in data entry areas of the transaction document generated in step 306. As a second example, transaction data is extracted from OCR fields that are included in the transaction document generated in step 306. The OCR fields may be designed to look like LCD digits. For instance, a driver providing the non-emergency medical transportation fills in the OCR fields with a client's identification (e.g., first initial, middle initial and first four letters of the client's last name), a pickup time, and a drop-off time. SVE 114 (see FIG. 1) uses client records in database 118 (see FIG. 1) to identify the client associated with the extracted identification of the client. For instance, SVE 114 (see FIG. 1) uses database 118 (see FIG. 1) to identify the client associated with the extracted last four digits of the client's home phone number. The SVE 114 (see FIG. 1) then locates any transaction records in database 118 (see FIG. 1) that are associated with the identified client and that also include other extracted bar code data and/or extracted transaction data (e.g., service date and type of trip).

In a second embodiment, CVSP computing unit 102 (see FIG. 1) displays a list of transaction records (a.k.a. filtered list) that filters out any transaction record received in step 302 that includes: (1) an identifier of a client that does not match the identifier of the client in the transaction data extracted in step 310; (2) an identifier of a health care provider that does not match the provider ID included in the bar code data extracted in step 310; and (3) a date to provide a health care service that does not match the service date in the bar code data extracted in step 310. In the second embodiment of this paragraph, a user of CVSP computing unit 102 (see FIG. 1) checks the filtered list of transaction records in step 312 and determines whether the extracted bar code data and extracted transaction data matches any of the transaction records in the filtered list.

If step 312 determines that the extracted bar code data and the extracted transaction data are not included in any transaction record of the set of transaction records received in step 302 (i.e., the extracted bar code data and extracted transaction data do not match analogous data in an authorized transaction), then in step 314, verification software executing in CVSP computing unit 102 (see FIG. 1) identifies the transaction as a non-authorized transaction (i.e., a fraud or potential fraud of the provider billing for a non-authorized transaction is identified by the verification software). For example, identifying the transaction as a non-authorized transaction includes finding that no transaction record in the set of transaction records received in step 302 includes the provider ID and service date in the extracted bar code data, and the client identifier in the transaction data. Continuing the same example, even if a transaction record in the set of transaction records includes a client identifier that matches the client identifier in the extracted transaction data and a provider identifier that matches the provider ID in the extracted bar code data, but also includes a date of providing a health care service that does not match the service date in the extracted bar code data, then the No branch of step 312 is still taken. Still continuing the same example, if a transaction record in the set of transaction records includes a client identifier that matches the client identifier in the extracted transaction data and a date of providing a health care service that matches the service date in the extracted bar code data, but also includes a provider identifier that does not match the provider ID in the extracted bar code data, then the No branch of step 312 is still taken.

If the SVE 114 (see FIG. 1) automatically performs step 312, then SVE 114 (see FIG. 1) also automatically performs step 314. If a user is checking a filtered list of transaction records in step 312, then the user identifies the non-authorized transaction in step 314.

In step 316, payment to the provider for providing the service is denied. In one embodiment, a payer entity denies the payment in step 316 (e.g., payer computing unit 108 of FIG. 1 automatically denies the payment). In another embodiment, the payer entity has previously given the CVSP permission to authorize or not authorize a payment for the service, and in step 316, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 318, CVSP computing unit 102 (see FIG. 1) creates and stores a record in database 118 (see FIG. 1). The record stored in step 318 indicates the suspected fraud of attempting to bill for the non-authorized transaction identified in step 314. The stored record is to be included in an exception report that identifies fraudulent and/or suspected fraudulent health care claims.

In step 320, report generator 116 (see FIG. 1) generates the exception report 131 (see FIG. 1). In one embodiment, exception report 131 (see FIG. 1) is generated dynamically in real-time in response to a user's action in step 320 (e.g., the user clicks on a graphical user interface element to display the exception report). The user is, for example, a user of CVSP computing unit 102 (see FIG. 1), health care provider computing unit 106 (see FIG. 1) or payer computing unit 108 (see FIG. 1). The dynamically generated exception report includes up-to-the-minute data. In another embodiment, report generator 116 (see FIG. 1) uploads the exception report to the website provided by CVSP web server 104 (see FIG. 1) for distribution to users of the CVSP website. In step 322, the fraudulent health care claim detection process ends.

Returning to step 312, if the extracted bar code data and the extracted transaction data matches a transaction in the set of transactions received in step 302, then in one embodiment in which the bar code includes a code that uniquely identifies the sheet of paper on which the transaction document is printed in step 306, the process of detecting fraudulent health care claims continues with step 324 of FIG. 3B.

In step 324 of FIG. 3B, a signature verification engine 114 (see FIG. 1) determines whether the extracted signature is valid (i.e., determines whether the extracted signature matches a reference signature included in database 118 (see FIG. 1)). The process employed by the signature verification engine is described below relative to FIG. 3D.

In an embodiment in which the health care provider is providing non-emergency medical transportation, if step 324 determines that a driver filled in details for a trip on form 132 (see FIG. 1) (i.e., the transaction document generated in step 306 of FIG. 3A) but the signature area on form 132 (see FIG. 1) is empty, then CVSP computing unit 102 (see FIG. 1) stores the trip in database 118 (see FIG. 1) and associates the trip with a no-show/cancel indicator. Further, if the health care provider never submits a signature for a trip stored in database 118 (see FIG. 1), a no-show/cancel indicator is associated with the trip. Such trips that are associated with the no-show/cancel indicator and that are also included in the trips that the health care provider bills are included in a report of fraudulent billing claims that are not signature-related fraud.

If step 324 determines that the signature extracted in step 310 is invalid, then in step 326, signature verification engine 114 (see FIG. 1) identifies the signature as being a suspected fraudulent signature. For example, the suspected fraudulent signature identified in step 310 indicates that the provider is billing for the service, but the service was not provided to the client. In step 328, payment to the provider for providing the service is denied. In one embodiment, a payer entity denies the payment in step 328. In another embodiment, the payer entity has previously given the CVSP permission to authorize or not authorize a payment for the service, and in step 328, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 330, CVSP computing unit 102 (see FIG. 1) creates and stores a record of the suspected fraudulent signature and its related transaction in database 118 (see FIG. 1). The stored record is to be included in an exception report that identifies fraudulent and/or suspected fraudulent health care claims.

In step 332, report generator 116 (see FIG. 1) generates the exception report 131 (see FIG. 1). In one embodiment, exception report 131 (see FIG. 1) is generated dynamically in real-time in response to a user's action in step 332 (e.g., the user clicks on a graphical user interface element to display the exception report). The user is, for example, a user of CVSP computing unit 102 (see FIG. 1), health care provider computing unit 106 (see FIG. 1) or payer computing unit 108 (see FIG. 1). The dynamically generated exception report includes up-to-the-minute data. In another embodiment, report generator 116 (see FIG. 1) uploads the exception report to the website provided by CVSP web server 104 (see FIG. 1) for distribution to users of the CVSP website. In step 334, the fraudulent health care claim detection process ends.

Returning to step 324, if the signature verification engine determines that the extracted signature is valid, then the fraudulent health care claim detection process continues with step 336 of FIG. 3C.

In inquiry step 336 of FIG. 3C, verification software running on computing unit 102 (see FIG. 1) determines whether the transaction is a re-submitted transaction (i.e., whether a claim for payment for the service is being submitted a second time). If step 336 determines that a claim for payment for the service is being re-submitted, then in step 338 verification software executing on CVSP computing unit 102 (see FIG. 1) identifies a suspected fraudulent attempt to bill the same claim for payment of the service twice.

In one embodiment, the health care provider is required to use the CVSP website to print out multiple bar code/signature forms 132 (see FIG. 1) in step 306 so that each form 132 includes a bar code that includes a code (a.k.a. unique code) that is unique to that form (i.e., in accordance with a previous agreement between the health care provider and the CVSP, the health care provider does not make photocopies of or otherwise copy a form 132 of FIG. 1 to create multiple forms). An indication that the health care provider agreed to not copy form 132 (see FIG. 1) is stored, for example, in database 118 (see FIG. 1). In the embodiment described in this paragraph, in step 310 (see FIG. 3A) the extractor 117 (see FIG. 1) extracts the unique code from the bar code data. A unique code field is included in database 118 (see FIG. 1), which associates any unique code stored in the unique code field with the transaction record matched in step 324 (see FIG. 3B) (also referred to in this paragraph as the matched transaction record). If the unique code field associated with the matched transaction record is empty at the Yes branch of step 324 (see FIG. 3B), then an additional step (not shown) that proceeds from the Yes branch of step 324 (see FIG. 3B) stores the extracted unique code in the unique code field, and the process continues with step 336. Furthermore, in the embodiment described in this paragraph, the Yes branch of step 336 is taken if the unique code extracted in step 310 (see FIG. 3A) matches a unique code stored in the unique code field that is associated with the matched transaction record in database 118 (see FIG. 1).

As one example of using the unique code in step 336, a transportation provider accesses the CVSP website to print out 10 log form sheets (i.e., Sheets 1 through 10), so that each sheet has a bar code that includes a unique code that uniquely identifies the sheet. For instance unique code C10 identifies Sheet 10. Bob Smith is a client who signs for a non-emergency medical transportation return trip on Sheet 10. The 10 log form sheets are completed with signatures and transaction data and the transportation provider faxes the 10 completed log form sheets to the CVSP, but Sheet 10 is faxed twice—once by the tenth faxed sheet and once by the eleventh faxed sheet. Thus, extracted signature and extracted transaction data for the return trip for Bob Smith is received twice by the CVSP computing unit 102 (see FIG. 1), thereby creating a re-submission of a claim for payment of the return trip for Bob Smith (i.e., a duplicate claim for Bob Smith's return trip is submitted). Following step 324 (see FIG. 3B) in the processing of the tenth faxed sheet, the aforementioned additional step stores the unique code C10 in the unique code field associated with a transaction record R123 corresponding to Bob Smith's return trip. In the processing of the eleventh faxed sheet, verification software in step 336 determines that the unique code C10 extracted from the bar code on the eleventh faxed sheet matches the unique code C10 was previously stored in the unique code field associated with transaction record R123. Because of the unique code match determined in step 336, the process of FIGS. 3A-3C follows the Yes branch of step 336. Thus, the attempt to bill twice for the claim associated with Bob Smith's return trip is identified in step 338, payment for the duplicate claim for Bob Smith's return trip is denied in step 340, the CVSP computing unit 102 (see FIG. 1) creates a record of the fraud associated with the duplicate claim, and the CVSP computing unit stores the record of the duplicate claim fraud in database 118 (see FIG. 1). An exception report that includes the record of the duplicate claim fraud is generated by CVSP computing unit 102 (see FIG. 1) in step 344.

In step 340, payment to the provider for providing the service is denied. In one embodiment, a payer entity denies the payment in step 340. In another embodiment, the payer entity has previously given the CVSP permission to authorize or not authorize a payment for the service, and in step 340, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 342, CVSP computing unit 102 (see FIG. 1) creates and stores a record in database 118 (see FIG. 1). The record stored in step 342 indicates the suspected fraud of attempting to bill the same claim twice. The stored record is to be included in an exception report that identifies fraudulent and/or suspected fraudulent health care claims.

In step 344, report generator 116 (see FIG. 1) generates the exception report 131 (see FIG. 1). In one embodiment, exception report 131 (see FIG. 1) is generated dynamically in real-time in response to a user's action in step 344 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the website provided by CVSP web server 104 (see FIG. 1). In step 346, the fraudulent health care claim detection process ends.

Returning to step 336, if the transaction is not a re-submitted transaction, then in step 348 payment to the provider for providing the service is authorized. In one embodiment, a payer entity authorizes the payment in step 348. In another embodiment, the payer entity has previously given the CVSP permission to authorize or not authorize a payment for the service, and in step 348, the CVSP computing unit 102 (see FIG. 1) authorizes payment for the service via a payment request generated by MMIS integration unit 127 (see FIG. 1). In one embodiment, step 348 includes the CVSP computing unit revealing the entire Medicaid prior authorization number to the provider to indicate that payment is authorized.

In an alternate embodiment (not shown) in which the bar code does not include the code that uniquely identifies the sheet of paper on which the transaction document is printed, the Yes branch of step 324 proceeds to step 348 of FIG. 3C and then the process ends at step 346 of FIG. 3C. In the embodiment described in this paragraph, database 118 (see FIG. 1) includes a match field that is associated with each transaction record received in step 302 (see FIG. 3A). The match field includes, for example, a value of 0 to indicate that the associated transaction record has not been previously matched by extracted bar code data and extracted transaction data in step 324, or a value of 1 to indicate that the associated transaction record has been matched in step 324. In the embodiment described in this paragraph, an additional condition for proceeding along the Yes branch of step 324 is that the match field indicates that the transaction record has not been matched in a previous execution of step 324 (e.g., the match field includes a value of 0). Furthermore in the embodiment described in this paragraph, the Yes branch of step 324 proceeds to an additional step (not shown), in which the value in the match field is updated to the value (e.g., updated from 0 to 1) that indicates that step 324 matched the transaction record to the extracted bar code data and extracted transaction data.

FIG. 3D depicts a flow diagram of a process for verifying the signature extracted in step 310 (see FIG. 3A). The signature verification process begins at step 350. In step 352, SVE 114 (see FIG. 1) receives the transaction data, bar code data and signature extracted in step 310 of FIG. 3A (i.e., receives the extracted transaction data, the extracted bar code data and the extracted signature). In step 354, signature verification software 212 (see FIG. 2) receives the extracted signature while maintaining the integrity of the correlation between the signature and the extracted transaction data and extracted bar code data. In step 356, signature verification software 212 (see FIG. 2) retrieves one or more reference signatures from a reference signature table in database 118 (see FIG. 1).

In step 358, signature verification software 212 (see FIG. 2) compares the extracted signature to the one or more reference signature(s) retrieved in step 356 and determines a score that indicates whether the extracted signature matches a reference signature retrieved in step 356 based on predefined signature matching criteria. For example, a score of 100 indicates a close resemblance between the extracted signature and one of the retrieved reference signatures, and based on the predefined signature matching criteria the score of 100 indicates a match between the extracted signature and the reference signature.

If there are multiple reference signatures retrieved in step 356, then the score determined in step 358 is the score associated with the reference signature of the multiple retrieved reference signatures that most closely resembles the extracted signature based on the predefined signature matching criteria.

The extracted signature is a verified (i.e., valid) signature if the score determined in step 358 satisfies the predefined signature matching criteria. In one embodiment, the extracted signature is verified if the score determined in step 358 exceeds a predefined threshold score level.

The extracted signature is determined to be a suspected fraudulent signature (i.e., an invalid signature) if the score determined in step 358 fails to satisfy the predefined signature matching criteria. In one embodiment, the signature is a suspected fraudulent signature if the score determined in step 358 does not exceed the predefined threshold score level. A score that does not exceed the predefined threshold score level indicates that the extracted signature does not match any of the one or more reference signatures retrieved in step 356.

In step 360, SVE 114 (see FIG. 1) stores the score determined in step 358 in a scoring results table in database 118 (see FIG. 1).

If there is no reference signature for the extracted signature being processed in step 358, then signature verification software 212 (see FIG. 2) stores the first signature processed in step 358 as a reference signature for the client.

In step 366, report generator 116 (see FIG. 1) generates an exception report 131 (see FIG. 1) that includes any suspected fraudulent signatures identified by SVE 114 (see FIG. 1). The generation of the exception report in step 366 is performed in response to a user (e.g., a user of the CVSP website) activating a graphical user interface (GUI) element (or otherwise interacting with CVSP web server 104 of FIG. 1 or CVSP computing unit 102 of FIG. 1) to dynamically generate and display an exception report in real-time. Further, the generation of the exception report in step 366 includes SVE 114 (see FIG. 1) identifying one or more signatures received in step 356 as suspected fraudulent signatures based on one or more scores being below a predetermined threshold (i.e., a minimum acceptable score), where the one or more scores are determined in step 358 for the one or more signatures. Still further, the generation of the exception report in step 356 includes report generator 116 (see FIG. 1) pulling one or more computer files that include one or more suspected fraudulent signatures. In step 368, CVSP web server 104 receives exception report 131 (see FIG. 1) and report distributor 130 (see FIG. 1) distributes the exception report. In one embodiment, the exception report is distributed to payer computing unit 108 (see FIG. 1) via the CVSP website. The exception report is available in real-time for web-based access and printing. In one example, a user of the payer computing unit 108 (see FIG. 1) receives an email notification when a new exception report is in the queue. In another embodiment, the exception report is distributed to health care provider computing unit 106 (see FIG. 1) via the CVSP website, and users of computing unit 106 (see FIG. 1) receive a notification (e.g., email notification) when a new exception report is in the secure queue. The signature verification process ends at step 370.

### EXAMPLE

### Non-Emergency Medical Transportation

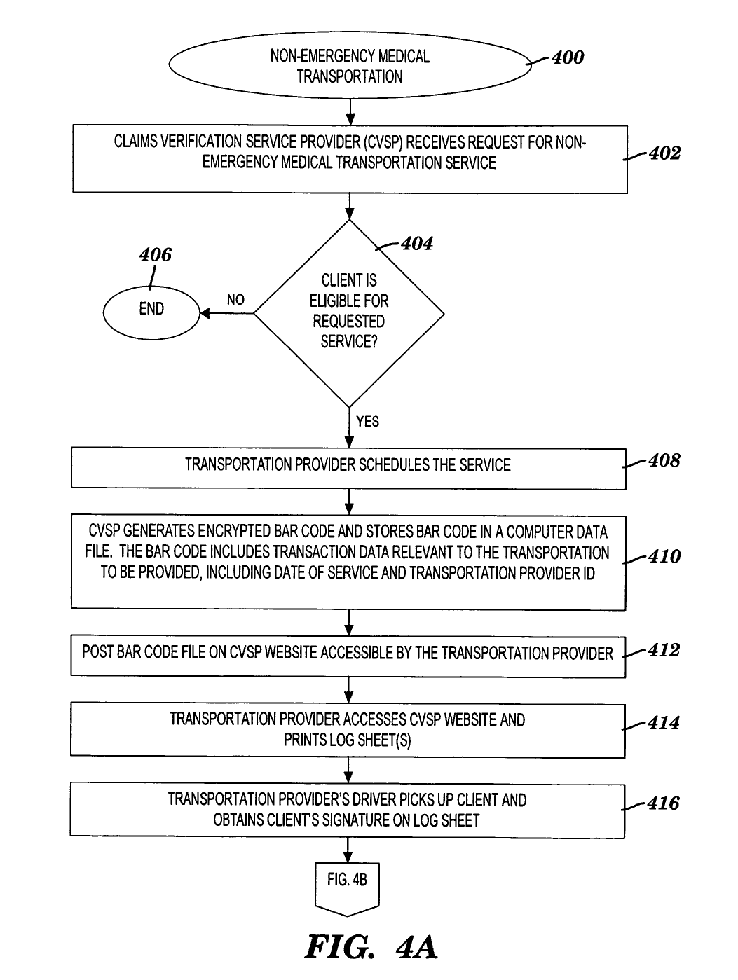

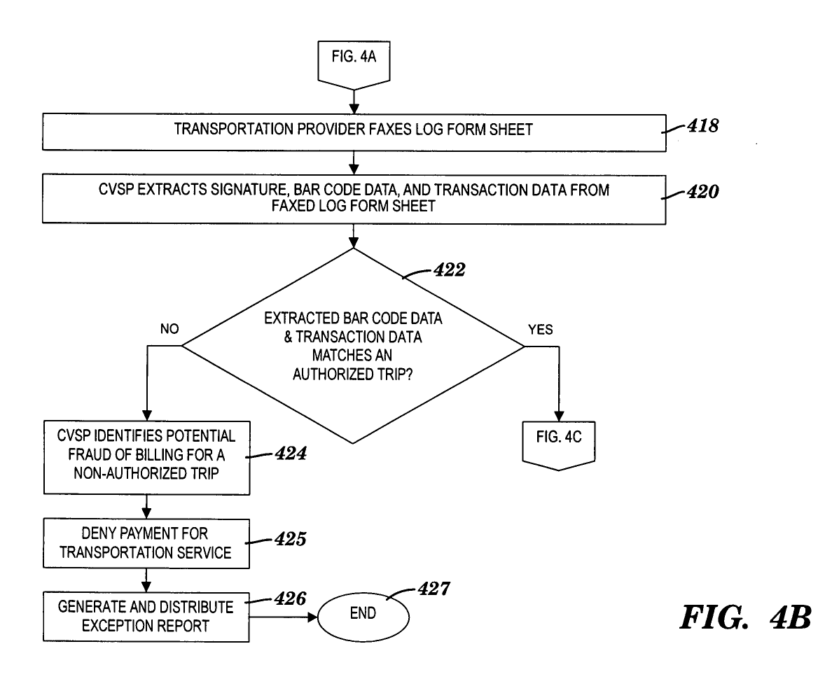

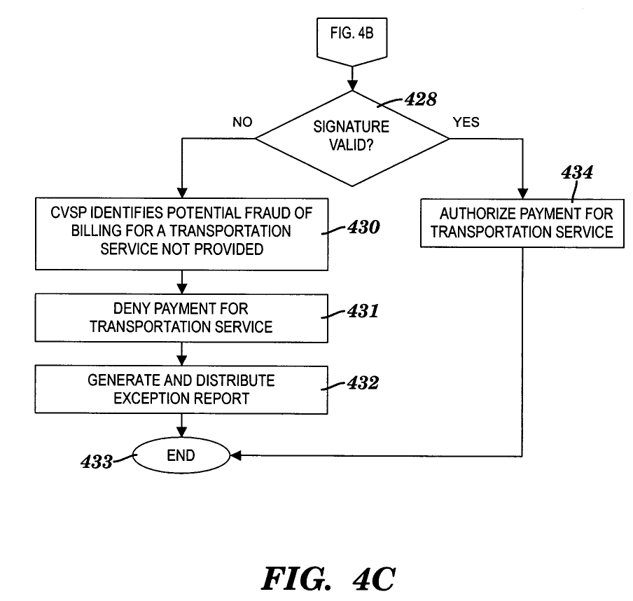

FIGS. 4A-4C depict a flow diagram of a computer-implemented process for detecting a fraudulent health care claim associated with non-emergency medical transportation, in accordance with embodiments of the present invention. The non-emergency medical transportation fraud detection process begins at step 400 of FIG. 4A. In step 402, CVSP computing unit 102 (see FIG. 1) receives a request for a non-emergency medical transportation service to be provided to a client by a transportation provider. The request for the transportation service is received from, for example, the client or a health care provider. In the scenario described in this section, computing unit 106 (see FIG. 1) is utilized by the transportation provider.

In inquiry step 404, CVSP computing unit 102 (see FIG. 1) accesses eligibility data stored in database 118 (see FIG. 1) to determine if the client is eligible to receive a payment for the requested transportation service. In one embodiment, the client is eligible for a payment from Medicaid if the date the transportation is to be provided is prior to the date the client's Medicaid eligibility ends, which is an eligibility end date that was previously received by CVSP computing unit 102 (see FIG. 1) and stored in database 118 (see FIG. 1). If step 404 determines that the client is not eligible for the requested service, the fraudulent medical transportation claim detection process ends at step 406. If step 404 determines that the client is eligible for the requested service, then in step 408, the transportation provider schedules the non-emergency medical transportation service.

In one embodiment, the CVSP computing unit 102 (see FIG. 1) receives a payment authorization number between steps 404 and 408. The authorization number permits the transportation provider to receive payment for providing the non-emergency medical transportation service to the client (e.g., a Medicaid prior authorization number). The CVSP does not show or shows only part of the authorization number to the transportation provider (e.g., via the CVSP website provided by CVSP web server 104 of FIG. 1) until payment for the transportation service is approved by the process of FIGS. 4A-4C. The authorization number is received in response to a prior authorization/approval request generated by MMIS integration unit 127 (see FIG. 1).

In step 410, bar code generator 112 (see FIG. 1) generates an encrypted bar code that is stored in a computer data file. The bar code includes transaction data relevant to the non-emergency medical transportation to be provided to the client, including the date the transportation service is provided and an identifier of the transportation provider.

In step 412, the bar code file generated in step 410 is posted on the CVSP website provided by CVSP web server 104 (see FIG. 1). In one embodiment, the CVSP website is a secure website that is HIPAA-compliant. In step 414, the transportation provider computing unit 106 (see FIG. 1) accesses the CVSP website and prints one or more log sheets generated by bar code/signature form generator 126 (see FIG. 1). In one embodiment, a log sheet is a paper-based artifact. Each log sheet is printed, for example, on a sheet of paper and includes the bar code and one or more areas to receive handwritten signatures from clients and other transaction data from the transportation provider (e.g., a driver). In one embodiment, the other transaction data is written on the log sheet by a driver and includes an indication of whether the trip is a take trip or a return trip, a pickup time, a drop-off time, and the client's name (or a portion of the client's name). In another embodiment in which CVSP computing unit 102 (see FIG. 1) has received and stored the non-emergency medical transportation provider's trips, form 132 (see FIG. 1) is a pre-filled form that includes a bar code and client names pre-printed in areas substantially close to corresponding signature receiving areas. The bar code included on the pre-filled form stores trip identifiers, where each signature on the form corresponds to one of the stored trip identifiers. As used herein, a take trip is defined as a trip by which a client is taken to an appointment location (e.g., health care facility) from a pickup location (e.g., the client's home). As used herein, a return trip is defined as a trip by which a client is returned to the client's pickup location (e.g., the client's home) from the appointment location (e.g., health care facility). In step 416, the transportation provider picks up the client at the pickup location, fills in the other transaction data on the log form sheet, and obtains the client's handwritten signature on the log form sheet. The fraudulent medical transportation claim detection process continues with step 418 of FIG. 4B.

In step 418 of FIG. 4B, the transportation provider uses fax machine 136 (see FIG. 1) to fax the log form sheet that includes the bar code, the client's handwritten signature and the transaction data filled in by the driver. In step 420, an automated fax system provided by CVSP computing unit 102 receives the fax sent in step 418 and converts the fax into an electronic document (e.g., a digital image file). Step 420 also includes CVSP computing unit 102 extracting the transportation provider ID and service date from the bar code and extracting data from each data entry area on the log form sheet. Each data entry area of the log form sheet includes a signature and the signature's associated transaction data that was handwritten by the driver. Step 420 further includes CVSP computing unit 102 (see FIG. 1) storing the log form sheet's extracted data entry areas in multiple records in database 118 (see FIG. 1) along with the data extracted from the log form sheet's bar code. In one embodiment, the data entry areas of the log form sheet are stored in the multiple records of database 118 (see FIG. 1) in a one-to-one correspondence. The storing of the aforementioned extracted data (i.e., from the data entry areas and from the bar code) in step 420 associates the non-emergency medical transportation transaction with a handwritten signature and with a transportation provider.

If SVE 114 (see FIG. 1) determines in inquiry step 422 that the extracted bar code data and extracted transaction data do not match a transaction record for an authorized trip that was previously stored in database 118 (see FIG. 1), then in step 424 SVE 114 (see FIG. 1) identifies a fraudulent or potentially fraudulent health care claim that includes billing for a non-emergency medical transportation service having an authorization issue. For example, the fraudulent health care claim identified in step 424 is a case in which (1) non-emergency medical transportation is provided to a client but the trip was not authorized by a payer, (2) non-emergency medical transportation was authorized for a date that is different from the service date in the extracted transaction data, or (3) non-emergency medical transportation was authorized for an appointment location that is different from the appointment location in the extracted transaction data.

In one embodiment, steps 422 & 424 are performed automatically by SVE 114 (see FIG. 1). In the embodiment described in this paragraph, the extracted transaction data includes an identification of the client, such as the client's name, a portion of the client's name, the client's home phone number or a portion (e.g., the last four digits) of the client's home phone number. As one example, the last four digits of the client's home phone number were previously encoded in OMR areas that are included in data entry areas of the log form sheet printed in step 414 (see FIG. 4A). As a second example, transaction data is extracted from OCR fields that are included in the log sheet printed in step 414 (see FIG. 4A). The OCR fields may be designed to look like LCD digits. For instance, a driver providing the non-emergency medical transportation fills in the OCR fields with a client's identification (e.g., first initial, middle initial and first four letters of the client's last name), a pickup time, and a drop-off time. SVE 114 (see FIG. 1) uses client records in database 118 (see FIG. 1) to identify the client associated with the extracted identification of the client. For instance, SVE 114 (see FIG. 1) uses database 118 (see FIG. 1) to identify the client associated with the extracted last four digits of the client's home phone number. The SVE 114 (see FIG. 1) then locates any transaction records in database 118 (see FIG. 1) that are associated with the identified client and that also include other extracted bar code data and extracted transaction data (e.g., service date and type of trip).

In another embodiment, SVE 114 (see FIG. 1) automatically displays to a user a list of transaction records that is filtered according to the process described above relative to step 422 (see FIG. 4B). The user checks the list and determines whether the extracted bar code data and extracted transaction data matches a transaction record for an authorized trip that was previously stored in database 118 (see FIG. 1). If the user finds a matching authorized trip in step 422, then the user selects the authorized trip in the list to identify the fraud or potential fraud in step 424, and steps 425 and 426 are automatically performed by one or more computing units in FIG. 1.

In step 425, payment to the transportation provider for the transportation service requested in step 402 (see FIG. 4A) is denied (i.e., is not authorized). In one embodiment, the payer denies the payment in step 425. In another embodiment, the CVSP computing unit 102 (see FIG. 1) automatically denies the payment in step 425 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 425 includes preventing the complete authorization number (e.g., the complete Medicaid prior authorization number) from being received or viewed by the transportation provider.

In step 426, report generator 116 (see FIG. 1) generates exception report 131, which includes the fraudulent or potentially fraudulent health care claim identified in step 424. In one embodiment, exception report 131 (see FIG. 1) is generated dynamically in real-time in response to a user's action in step 426 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., transportation provider or payer). In still another embodiment, steps 366 and 368 of FIG. 3D are substituted for step 426. The fraud detection process for non-emergency medical transportation ends at step 427.

Returning to step 422, if SVE 114 (see FIG. 1) determines that the extracted bar code data and extracted transaction data matches a transaction record for an authorized trip that was previously stored in database 118 (see FIG. 1), then the fraud detection process for non-emergency medical transportation continues with steps 352-360, as described above relative to FIG. 3D, followed by step 428 of FIG. 4C.

SVE 114 (see FIG. 1) determines in step 428 of FIG. 4C that the extracted signature is valid or not valid based on whether the score determined in step 358 (see FIG. 3D) meets predetermined criteria. In one embodiment, the extracted signature is valid if the score determined in step 358 (see FIG. 3D) is greater than a predefined threshold value and is invalid if the score is less than or equal to the predefined threshold value. If the extracted signature is determined to be not valid at step 428, then in step 430 SVE 114 (see FIG. 1) identifies a fraudulent or potentially fraudulent health care claim that includes billing for a non-emergency medical transportation service that is not provided.

In step 431, payment to the transportation provider for the transportation service requested in step 402 (see FIG. 4A) is denied (i.e., is not authorized). In one embodiment, the payer denies the payment in step 431. In another embodiment, the CVSP computing unit 102 (see FIG. 1) automatically denies the payment in step 431 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 431 includes preventing the complete authorization number (e.g., the complete Medicaid prior authorization number) from being received or viewed by the transportation provider.

In step 432, CVSP computing unit 102 (see FIG. 1) generates exception report 131 (see FIG. 1), which includes the fraudulent or potentially fraudulent health care claim identified in step 430. In one embodiment, exception report 131 (see FIG. 1) is generated dynamically in real-time in response to a user's action in step 432 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., transportation provider or payer). In still another embodiment, steps 366 and 368 of FIG. 3D are substituted for step 432. The fraudulent claim detection process for non-emergency medical transportation ends at step 433.

Returning to step 428, if SVE 114 (see FIG. 1) determines that the signature is valid, then in step 434 SVE 114 (see FIG. 1) verifies that the transportation provider provided the requested non-emergency medical transportation service to the client, and the trip was provided to the authorized location on the authorized date. Furthermore, step 434 includes the payer authorizing payment to the transportation provider for the non-emergency transportation service. In another embodiment, per a prior agreement between the payer and the CVSP, the payer permits the CVSP to authorize payments to transportation providers, and step 434 includes the CVSP authorizing payment to the transportation provider for providing the non-emergency transportation service. Following step 434, the fraud detection process of FIGS. 4A-4C ends at step 433.

In an alternate embodiment (not shown), the bar code on each log sheet includes a unique code (i.e., a code that uniquely identifies the log sheet), and the transportation provider is required to use the CVSP website to print out multiple log form sheets and is not permitted to photocopy a log form sheet. In the embodiment described in this paragraph, in step 420 (see FIG. 4B) the extractor 117 (see FIG. 1) extracts the unique code from the bar code data. A unique code field is included in database 118 (see FIG. 1), which associates any unique code stored in the unique code field with the transaction record matched in step 422 (also referred to in this paragraph as the matched transaction record). If the unique code field associated with the matched transaction record is empty at the Yes branch of step 422, then an additional step (not shown) that proceeds from the Yes branch of step 422 stores the extracted unique code in the unique code field, and the non-emergency medical transportation fraud detection process continues with a logical flow that is analogous to steps 336, 338, 340, 342, 344, 346 and 348, which are described above relative to FIG. 3C.

In another embodiment, the signature collection and transmission steps described above (e.g., step 416 of FIG. 4A and step 418 of FIG. 4B) are replaced with a driver collecting signatures of clients on a smartphone or a personal digital assistant and then transmitting the signatures to the CVSP web server 104 (see FIG. 1). The CVSP computing unit receives the collected signatures and stores the signatures in database 118 (see FIG. 1).

### EXAMPLE

### Filling a Prescription

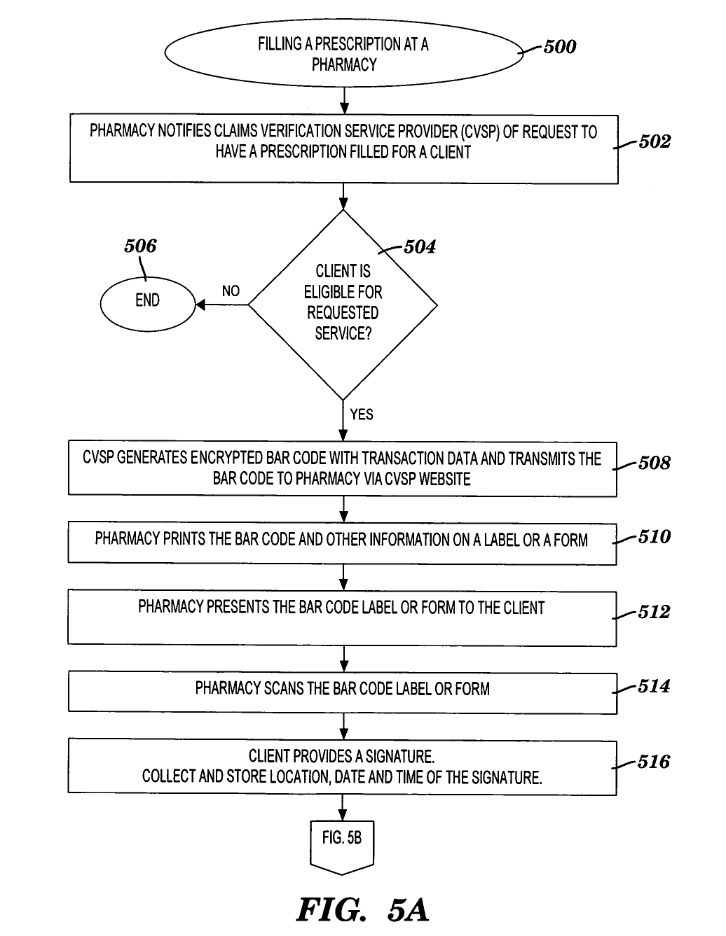

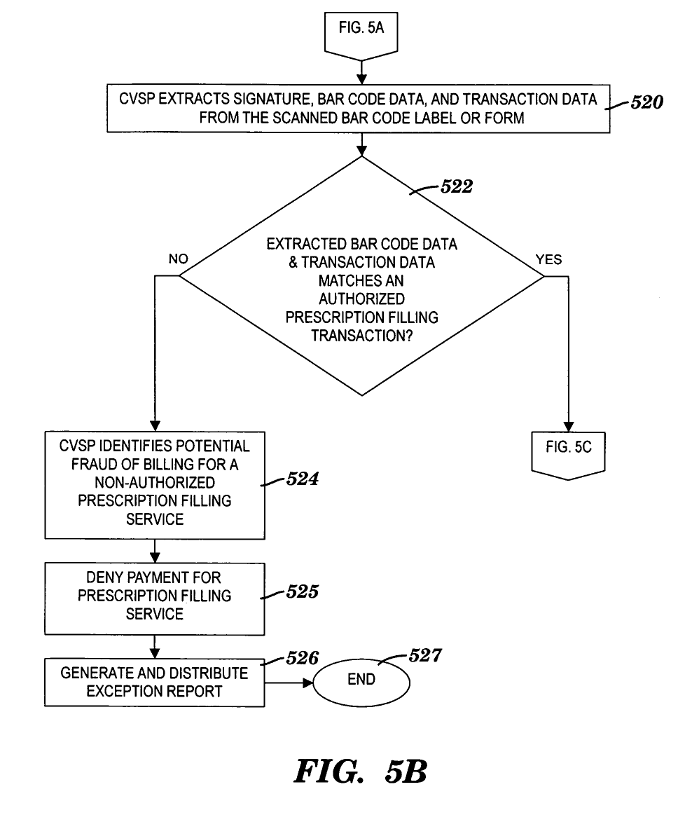

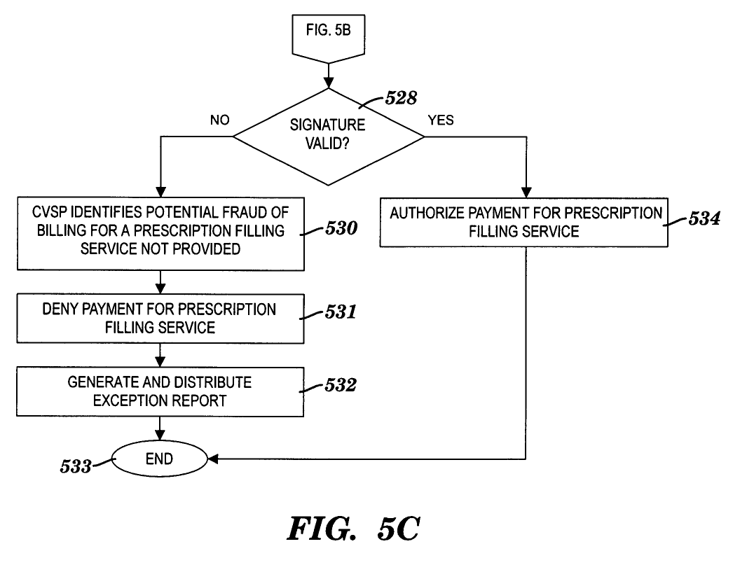

FIGS. 5A-5C depict a flow diagram of a computer-implemented process for detecting a fraudulent health care claim associated with filling a prescription at a pharmacy, in accordance with embodiments of the present invention. In the example described in this section, the pharmacy is the health care provider. Furthermore, in the example described in this section, computing unit 106 (see FIG. 1) is utilized by the pharmacy and is referred to as pharmacy computing unit 106 (see FIG. 1). The fraud detection process of FIGS. 5A-5C begins at step 500. In step 502, pharmacy computing unit 106 (see FIG. 1) sends a request to the CVSP computing unit 102 (see FIG. 1). The request sent in step 502 indicates a request to have a prescription filled for a client. In inquiry step 504, CVSP computing unit 102 (see FIG. 1) accesses eligibility data stored in database 118 (see FIG. 1) to determine if the client is eligible for the requested prescription filling service (e.g., checks the client's Medicaid eligibility). If step 504 determines that the client is not eligible for the requested prescription filling service, then the fraud detection process for prescription claims ends at step 506. If step 504 determines that the client is eligible for the requested prescription filling service, then in step 508 bar code generator 112 (see FIG. 1) generates an encrypted bar code that includes transaction data relevant to the prescription filling request and transmits the bar code to pharmacy computing unit 106 (see FIG. 1) via a HIPAA-compliant website (i.e., the CVSP website provided by CVSP web server 104 of FIG. 1).

In step 510, pharmacy computing unit 106 (see FIG. 1) prints the bar code and other information on a label or a form 132 (see FIG. 1). In step 512, the pharmacy presents to the client the label or form printed in step 510 (e.g., together with the filled prescription). In step 514, the pharmacy scans the label or form 132 (see FIG. 1) that includes the bar code generated in step 508. In step 516, the client provides a signature in response to accepting the filled prescription. In one embodiment, the client provides a biometric signature. Providing a biometric signature includes, for example, signing the client's name on a digital pen pad device (a.k.a. graphics tablet, digitizer tablet or pen tablet).

In another embodiment, the client handwrites the signature on a paper-based artifact (e.g., a log sheet printed on paper) that also includes the bar code generated in step 508. In the case of the client handwriting the signature on the paper form, the scanning of the form in step 514 may be performed after step 516 so that the signature is also scanned. Also in step 516, the signature-related data (e.g., location, time and date of the signature) is collected and stored. For example, if the client provides a biometric signature on a digital pen pad device, the digital pen pad device or a device coupled thereto stores the location and the date and time that the biometric signature was provided. The location associated with providing the biometric signature is the location of the device (e.g., digital pen pad device) when the device accepts the biometric signature and is provided by, for example, a Global Positioning System (GPS) incorporated in or coupled to the device. The date and time associated with providing the biometric signature are provided by, for example, a clock internal to or coupled to the device (e.g., digital pen pad device) that accepts the biometric signature.

In still another embodiment, the client handwrites the signature on a paper form in step 514, where the paper form also includes the bar code generated in step 508, and in step 516 a representative of the pharmacy uses fax machine 136 (see FIG. 1) to fax the paper form to an automated fax service coupled to the CVSP computing unit 102 (see FIG. 1).

In yet another embodiment, the location, date and time of the scan in step 514 may be collected and stored, instead of collecting and storing the location, date and time of providing the signature.

Following step 516, the fraud detection process for prescription filling services continues with step 520 in FIG. 5B.

In step 520 of FIG. 5B, SVE 114 (see FIG. 1) extracts the signature and the transaction data and bar code data from the scanned bar code label or form. The extracted transaction data and extracted bar code data is uploaded in step 520 to the CVSP website provided by CVSP web server 104 (see FIG. 1). The scanned handwritten signature on the paper form or biometric signature provided in step 516 (see FIG. 5A) is also uploaded to the CVSP website in step 520 and stored in database 118 (see FIG. 1). The uploading and storing in step 520 correlates the signature with the extracted transaction data and extracted bar code data and provides a record of the client signing for a specific script at a specific time and at a specific location.

If SVE 114 (see FIG. 1) determines in inquiry step 522 that the extracted bar code data and extracted transaction data does not match an authorized prescription filling transaction that was previously stored in database 118 (see FIG. 1), then in step 524 SVE 114 (see FIG. 1) identifies a fraudulent or potentially fraudulent health care claim that includes billing for a prescription filling service having an authorization issue. For example, the fraudulent health care claim identified in step 524 is a case in which a prescription filling service is provided to a client but the service was not authorized by a payer.

In step 525, payment to the pharmacy for the prescription filling service requested in step 502 (see FIG. 5A) is denied (i.e., is not authorized). In one embodiment, the payer denies the payment in step 525. In another embodiment, the CVSP computing unit 102 (see FIG. 1) automatically denies the payment in step 525 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment.

In step 526, report generator 116 (see FIG. 1) generates exception report 131 (see FIG. 1), which includes the fraudulent or potentially fraudulent health care claim identified in step 524. In one embodiment, exception report 131 (see FIG. 1) is generated dynamically in real-time in response to a user's action in step 526 (e.g., the user clicks on a graphical user interface element to display the exception report). The user is, for example, a user of CVSP computing unit 102 (see FIG. 1), pharmacy computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., pharmacy or payer). In still another embodiment, steps 366 and 368 of FIG. 3D are substituted for step 526. The fraud detection process for prescription filling services ends at step 527.

Returning to step 522, if SVE 114 (see FIG. 1) determines that the extracted bar code data and extracted transaction data matches an authorized prescription filling service that was previously stored in database 118 (see FIG. 1), then the fraud detection process for prescription filling services continues with steps 352-360, which are described above relative to FIG. 3D, followed by step 528 of FIG. 5C.

SVE 114 (see FIG. 1) determines in step 528 whether the signature provided in step 516 (see FIG. 5A) is valid or not based on the score determined in step 358 of FIG. 3D. If the signature is determined to be not valid at step 528, then in step 530 SVE 114 (see FIG. 1) identifies a fraudulent or potentially fraudulent health care claim that includes billing for a prescription filling service that is not provided.

In step 531, payment to the pharmacy for the service requested in step 502 (see FIG. 5A) is denied (i.e., is not authorized). In one embodiment, the payer denies the payment in step 531. In another embodiment, the CVSP computing unit 102 (see FIG. 1) automatically denies the payment in step 531 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 531 includes preventing the complete authorization number (e.g., the complete Medicaid prior authorization number) from being received or viewed by the pharmacy.

In step 532, CVSP computing unit 102 (see FIG. 1) generates exception report 131 (see FIG. 1), which includes the fraudulent or potentially fraudulent health care claim identified in step 530. In one embodiment, exception report 131 (see FIG. 1) is generated dynamically in real-time in response to a user's action in step 532 (e.g., the user clicks on a graphical user interface element to display the exception report). The user is, for example, a user of CVSP computing unit 102 (see FIG. 1), pharmacy computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., pharmacy or payer). Exception report 131 (see FIG. 1) is uploaded to CVSP web server 104 (see FIG. 1) and is distributed by report distributor 130 (see FIG. 1) to the pharmacy and/or the payer. In another embodiment, the exception report is accessed by the CVSP for internal use. In one embodiment, steps 366 and 368 of FIG. 3D are substituted for step 532. The fraudulent claim detection process for filling prescriptions at a pharmacy ends at step 533.

Returning to step 528, if SVE 114 (see FIG. 1) determines that the signature provided in step 516 (see FIG. 5A) is valid, then in step 534 SVE 114 (see FIG. 1) verifies that the pharmacy provided the requested prescription filling service to the client. Furthermore, step 534 includes the payer authorizing payment to the pharmacy for the prescription filling service. In another embodiment, per a prior agreement between the payer and the CVSP, the payer permits the CVSP to authorize payments to pharmacies, and step 534 includes the CVSP authorizing payment to the pharmacy for providing the prescription filling service. Following step 534, the fraud detection process of FIGS. 5A-5C ends at step 533.

In an alternate embodiment (not shown), the bar code on each form printed in step 510 includes a unique code (i.e., a code that uniquely identifies the form), and the pharmacy is required to use the CVSP website to print out multiple forms and is not permitted to photocopy a form. In the embodiment described in this paragraph, in step 520 (see FIG. 5B) the extractor 117 (see FIG. 1) extracts the unique code from the bar code data. A unique code field is included in database 118 (see FIG. 1), which associates any unique code stored in the unique code field with the transaction record matched in step 522 (also referred to in this paragraph as the matched transaction record). If the unique code field associated with the matched transaction record is empty at the Yes branch of step 522, then an additional step (not shown) that proceeds from the Yes branch of step 522 stores the extracted unique code in the unique code field, and the prescription filling fraud detection process continues with a logical flow that is analogous to steps 336, 338, 340, 342, 344, 346 and 348, which are described above relative to FIG. 3C. If the flow proceeds along the Yes branch of the step analogous to step 336 (see FIG. 3C), then SVE 114 (see FIG. 1) detects a re-submission of the same label or form 132 (see FIG. 1) (i.e., detects an attempt to bill twice for the same claim related to a pharmacy's filling of a prescription).

### EXAMPLE

### Physician's Office Visit

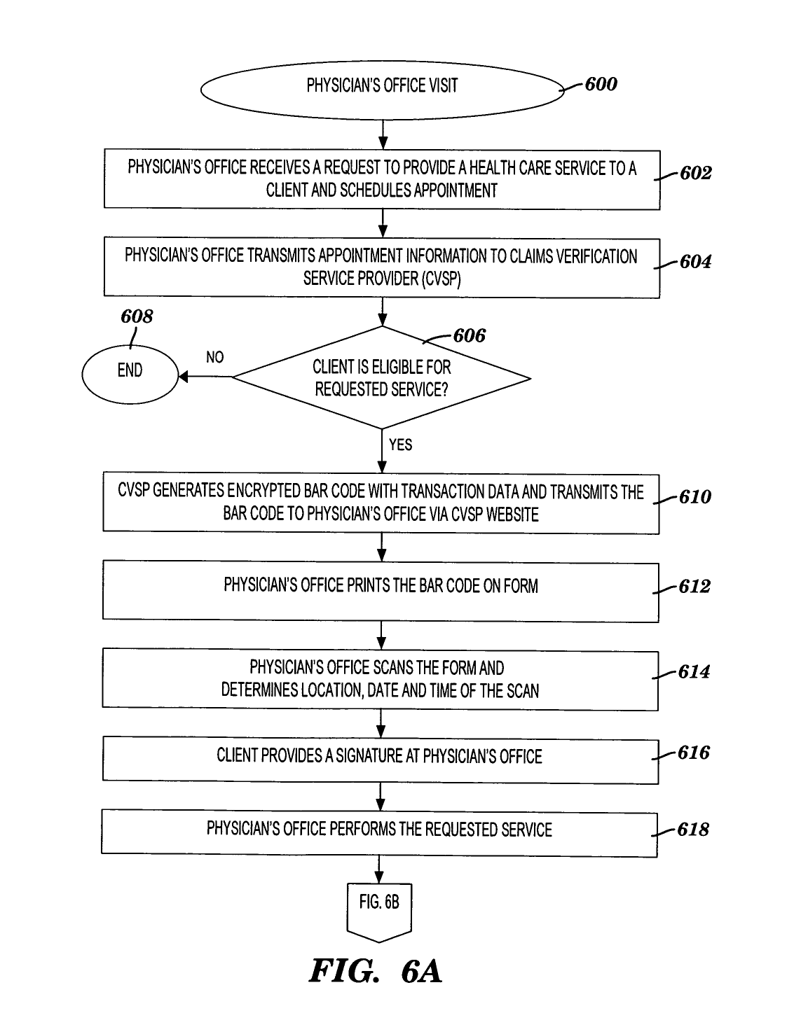

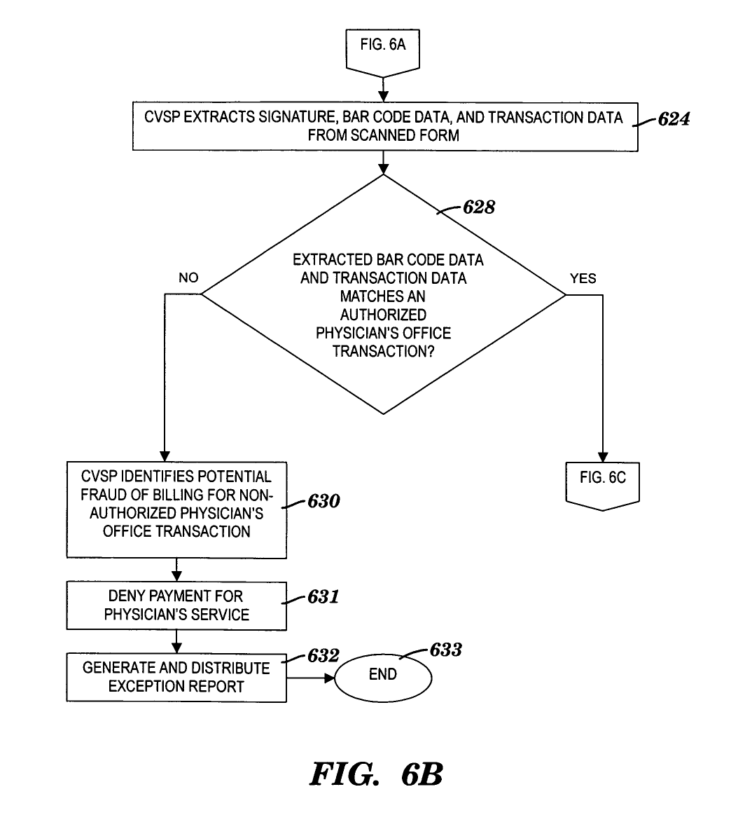

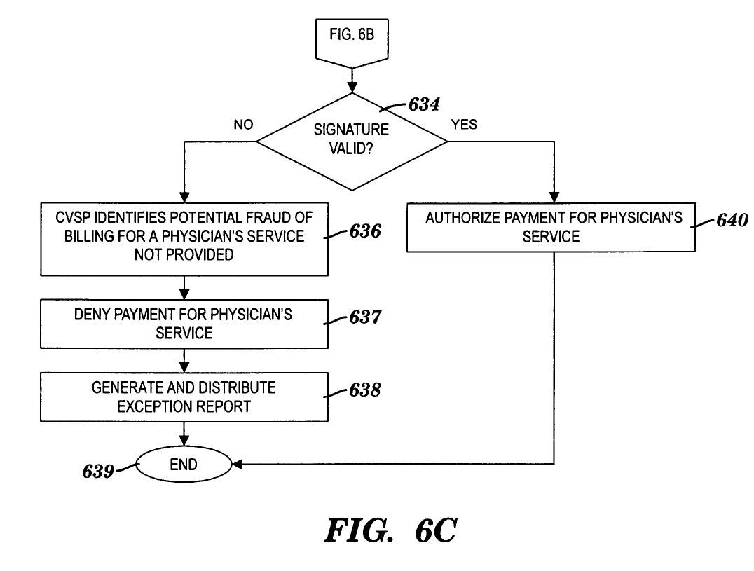

FIGS. 6A-6C depict a flow diagram of a computer-implemented process for detecting a fraudulent health care claim associated with a physician's service, in accordance with embodiments of the present invention. In the example described in this section, the physician's office is the health care provider. Furthermore, in the example described in this section, computing unit 106 (see FIG. 1) is utilized by the physician's office and is referred to as physician computing unit 106 (see FIG. 1). The fraud detection process of FIGS. 6A-6C begins at step 600. In step 602, physician computing unit 106 (see FIG. 1) receives a request to provide a health care service (a.k.a. physician's service) to a client and schedules an appointment for the client to receive the requested health care service.

In step 604, physician computing unit 106 (see FIG. 1) transmits information about the appointment to the CVSP computing unit 102 (see FIG. 1). In inquiry step 606, CVSP computing unit 102 (see FIG. 1) accesses eligibility data stored in database 118 (see FIG. 1) to determine if the client is eligible for the requested physician's service (e.g., checks the client's Medicaid eligibility). If step 606 determines that the client is not eligible for the requested physician's service, then the fraud detection process for physician's office visit claims ends at step 608. If step 606 determines that the client is eligible for the requested physician's service, then in step 610 bar code generator 112 (see FIG. 1) generates an encrypted bar code that includes transaction data relevant to the request for the physician's service and transmits the bar code to physician computing unit 106 (see FIG. 1) via a HIPAA-compliant website (i.e., the CVSP website provided by CVSP web server 104 of FIG. 1).

In step 612, physician computing unit 106 (see FIG. 1) prints the bar code and other information on a paper form 132 (see FIG. 1). In step 612, the pharmacy presents to the client the printed form. In step 614, a representative of the physician's office scans the form 132 (see FIG. 1) that includes the bar code generated in step 610. Also in step 614, scan-related data (e.g., location, time and date of the scan) is collected and stored. For example, if the representative of the physician's office uses scanning unit 136 (see FIG. 1) to scan form 132 (see FIG. 1), the scanning unit or a device coupled thereto stores the location and the date and time that the scan was performed. The location associated with scanning the form is the location of the scanning unit 136 (see FIG. 1) when the scanning unit scans the form and is provided by, for example, a Global Positioning System (GPS) incorporated in or coupled to the scanning unit. The date and time associated with the scan are provided by, for example, a clock internal to or coupled to the scanning unit 136 (see FIG. 1).

In step 616, the client provides a signature upon admittance to the physician's office. In one embodiment, the client provides a biometric signature. Providing a biometric signature includes, for example, signing the client's name on a digital pen pad device (a.k.a. graphics tablet, digitizer tablet or pen tablet).

In another embodiment, the client handwrites the signature on the paper form 132 (see FIG. 1) that also includes the bar code generated in step 610. In the case of the client handwriting the signature on the paper form, the scanning of the form in step 614 may be performed after step 616 so that the signature is also scanned.

In still another embodiment, the client handwrites the signature on a paper form in step 616, where the paper form also includes the bar code generated in step 610, and in step 616 a representative of the physician's office uses fax machine 136 (see FIG. 1) to fax the paper form 132 (see FIG. 1) to an automated fax service coupled to the CVSP computing unit 102 (see FIG. 1).

In yet another embodiment, the location, date and time of the signature provided in step 616 may be collected and stored, instead of collecting and storing the location, date and time of the scan.

In step 618, the physician's office performs the requested health care service. Following step 618, the fraud detection process for prescription filling services continues in FIG. 6B.

In step 624 of FIG. 6B, SVE 114 (see FIG. 1) extracts the signature, bar code data and associated transaction data from the scanned form 132 (see FIG. 1). In one embodiment, the extracted transaction data and extracted bar code data is uploaded in step 624 to the CVSP website provided by CVSP web server 104 (see FIG. 1). The scanned handwritten signature on the paper form or biometric signature provided in step 616 (see FIG. 6A) is also uploaded to the CVSP website in step 624 and stored in database 118 (see FIG. 1). The uploading and storing in step 624 correlates the signature with the extracted transaction data and extracted bar code data and provides a record of the client signing for admittance to the physician's office at a specific time and at a specific location.

If SVE 114 (see FIG. 1) determines in inquiry step 628 that the extracted bar code data and extracted transaction data do not match an authorized physician's office transaction that was previously stored in database 118 (see FIG. 1), then in step 630 SVE 114 (see FIG. 1) identifies a fraudulent or potentially fraudulent health care claim that includes billing for a non-authorized physician's service (i.e., the physician's service is provided to a client but the service was not authorized by a payer).

In step 631, payment to the physician's office for the physician's service requested in step 602 (see FIG. 6A) is denied (i.e., is not authorized). In one embodiment, the payer denies the payment in step 631. In another embodiment, the CVSP computing unit 102 (see FIG. 1) automatically denies the payment in step 631 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment.

In step 632, report generator 116 (see FIG. 1) generates exception report 131 (see FIG. 1), which includes the fraudulent or potentially fraudulent health care claim identified in step 630. In one embodiment, exception report 131 (see FIG. 1) is generated dynamically in real-time in response to a user's action in step 632 (e.g., the user clicks on a graphical user interface element to display the exception report). The user is, for example, a user of CVSP computing unit 102 (see FIG. 1), physician computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., physician or payer). In still another embodiment, steps 366 and 368 of FIG. 3D are substituted for step 632. The fraud detection process for a physician's office visit ends at step 633.

Returning to step 628, if SVE 114 (see FIG. 1) determines that the extracted bar code data and extracted transaction data match an authorized physician's office transaction that was previously stored in database 118 (see FIG. 1), then the fraud detection process for a physician's office visit continues with steps 352-360 of FIG. 3D followed step 634 of FIG. 6C.

SVE 114 (see FIG. 1) determines in step 634 of FIG. 6C whether the signature provided in step 616 (see FIG. 6A) is valid or not based on the score determined in step 358 of FIG. 3D. If the signature is determined to be not valid at step 634, then in step 636 SVE 114 (see FIG. 1) identifies a fraudulent or potentially fraudulent health care claim that includes billing for a physician's service that is not provided.

In step 637, payment to the physician's office for the service requested in step 602 (see FIG. 6A) is denied (i.e., is not authorized). In one embodiment, the payer denies the payment in step 637. In another embodiment, the CVSP computing unit 102 (see FIG. 1) automatically denies the payment in step 637 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 637 includes preventing the complete authorization number (e.g., the complete Medicaid prior authorization number) from being received or viewed by the transportation provider.

In step 638, CVSP computing unit 102 (see FIG. 1) generates exception report 131 (see FIG. 1), which includes the fraudulent or potentially fraudulent health care claim identified in step 636. In one embodiment, exception report 131 (see FIG. 1) is generated dynamically in real-time in response to a user's action in step 638 (e.g., the user clicks on a graphical user interface element to display the exception report). The user is, for example, a user of CVSP computing unit 102 (see FIG. 1), physician computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., physician or payer). In still another embodiment, steps 366 and 368 of FIG. 3D are substituted for step 638. The fraudulent claim detection process for physician's services ends at step 639.

Returning to step 634, if SVE 114 (see FIG. 1) determines that the signature provided in step 616 (see FIG. 6A) is valid, then in step 640 SVE 114 (see FIG. 1) verifies that the physician's office provided the requested physician's service to the client. Furthermore, step 640 includes the payer authorizing payment to the physician's office for the physician's service. In another embodiment, per a prior agreement between the payer and the CVSP, the payer permits the CVSP to authorize payments to physician's offices, and step 640 includes the CVSP authorizing payment to the physician's office for providing the physician's service. Following step 640, the fraud detection process of FIGS. 6A-6C ends at step 633.

In another embodiment, steps 614 and 616 of FIG. 6A are a first scan and first provision of the client's signature, respectively. In a step 620 (not shown) following step 618 in FIG. 6A, the client provides a second signature upon signing out of the physician's office. In a step 622 (not shown), which follows the aforementioned step 620, a representative of the physician's office scans the bar code a second time using the scanning unit 136 (see FIG. 1), which also determines the location, date and time of the second scan using the same GPS and clock-based techniques described above relative to step 614 (see FIG. 6A). Following step 622, the fraud detection process for services associated with a physician's office visit continues with the steps of FIG. 6B. In this embodiment, the two scans and two signatures provide a record of the client signing in and signing out for a physician's office visit at specific times and at a specific location.

In an alternate embodiment (not shown), the bar code generated on form 132 (see FIG. 1) in step 612 (see FIG. 6A) includes a unique code (i.e., a code that uniquely identifies the form), and the physician's office is required to use the CVSP website to print out multiple forms and is not permitted to photocopy a form. In the embodiment described in this paragraph, in step 624 (see FIG. 6B) the extractor 117 (see FIG. 1) extracts the unique code from the bar code data. A unique code field is included in database 118 (see FIG. 1), which associates any unique code stored in the unique code field with the transaction record matched in step 628 (also referred to in this paragraph as the matched transaction record). If the unique code field associated with the matched transaction record is empty at the Yes branch of step 628, then an additional step (not shown) that proceeds from the Yes branch of step 628 stores the extracted unique code in the unique code field, and the fraud detection process related to a transaction at a physician's office continues with a logical flow that is analogous to steps 336, 338, 340, 342, 344, 346 and 348, which are described above relative to FIG. 3C. If the flow proceeds along the Yes branch of the step analogous to step 336 (see FIG. 3C), then SVE 114 (see FIG. 1) detects a re-submission of the same form 132 (see FIG. 1) (i.e., detects an attempt to bill twice for the same claim related to a physician's office transaction).

### Computing System

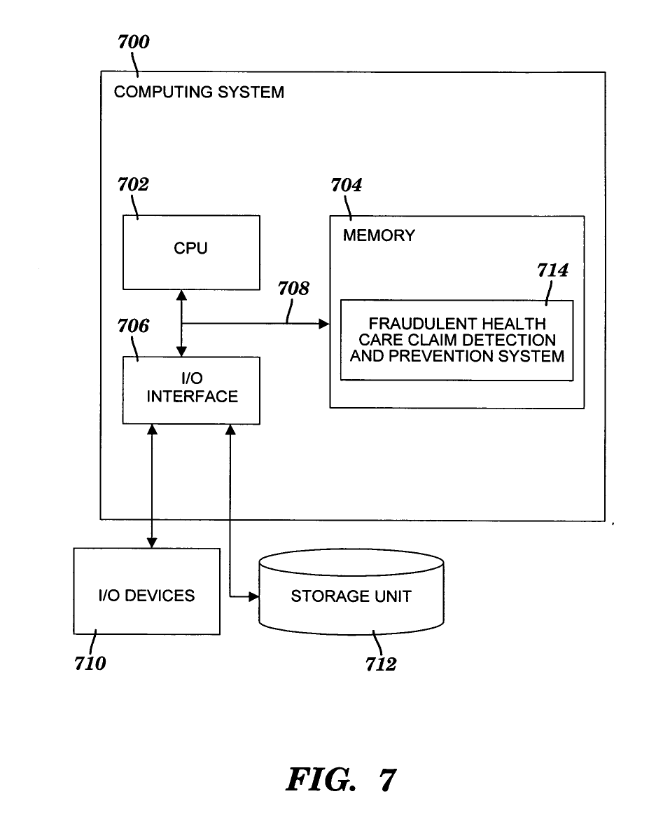

FIG. 7 is a block diagram of a computing system that implements the process of FIGS. 3A-3C, in accordance with embodiments of the present invention. Computing system 700 generally comprises a central processing unit (CPU) 702, a memory 704, an input/output (I/O) interface 706, a bus 708, I/O devices 710 and a computer data storage unit 712. Computing system 700 includes one or more of computing units 102, 104 and 106 shown in FIG. 1. CPU 702 performs computation and control functions of computing system 700. CPU 702 may comprise a single processing unit, or be distributed across one or more processing units in one or more locations (e.g., on a client and server).

Memory 704 may comprise any known type of data storage and/or transmission media, including bulk storage, magnetic media, optical media, random access memory (RAM), read-only memory (ROM), a data cache, a data object, etc. Cache memory elements of memory 704 provide temporary storage of at least some program code in order to reduce the number of times code must be retrieved from bulk storage during execution. Computer data storage unit 712 stores database 118 (see FIG. 1) and is, for example, a magnetic disk drive (i.e., hard disk drive) or an optical disk drive. Moreover, similar to CPU 702, memory 704 may reside at a single physical location, comprising one or more types of data storage, or be distributed across a plurality of physical systems in various forms. Further, memory 704 can include data distributed across, for example, a LAN, WAN or storage area network (SAN) (not shown).

I/O interface 706 comprises any system for exchanging information to or from an external source. I/O devices 710 comprise any known type of external device, including a display monitor, keyboard, mouse, printer, speakers, handheld device, facsimile, etc. Bus 708 provides a communication link between each of the components in computing system 700, and may comprise any type of transmission link, including electrical, optical, wireless, etc.

I/O interface 706 also allows computing system 700 to store and retrieve information (e.g., program instructions or data) from an auxiliary storage device (e.g., computer data storage unit 712). The auxiliary storage device may be a non-volatile storage device (e.g., a CD-ROM drive which receives a CD-ROM disk). Computing system 700 can store and retrieve information from other auxiliary storage devices (not shown), which can include a direct access storage device (DASD) (e.g., hard disk or floppy diskette), a magneto-optical disk drive, a tape drive, or a wireless communication device.

Memory 704 includes computer program code 714 that provides the logic for the health care claim fraud detection and prevention method and system disclosed herein (e.g., the processes of FIGS. 3A-3C, 3D, 4A-4C, 5A-5C and 6A-6C). Further, memory 704 may include other systems not shown in FIG. 7, such as an operating system (e.g., Linux) that runs on CPU 702 and provides control of various components within and/or connected to computing system 700.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code 714 for use by or in connection with a computing system 700 or any instruction execution system to provide and facilitate the capabilities of the present invention. For the purposes of this description, a computer-usable or computer-readable medium can be any apparatus that can contain, store, communicate, propagate, or transport the program code 714 for use by or in connection with the instruction execution system, apparatus, or device.

The computer-usable or computer-readable medium can be a semiconductor system, apparatus or device or another system, apparatus or device that utilizes electronic, magnetic, optical, electromagnetic or infrared data storage or data processing. Examples of a computer usable or computer-readable medium include a semiconductor or solid state memory, magnetic tape, a removable computer diskette, RAM, ROM, a rigid magnetic disk and an optical disk. Current examples of optical disks include compact disk-read-only memory (CD-ROM), compact disk-read/write (CD-R/W) and DVD.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

While embodiments of the present invention have been described herein for purposes of illustration, many modifications and changes will become apparent to those skilled in the art. For example, the transaction data embedded in the bar code generated in step 304 (see FIG. 3A) may be related to the provision of home health care services. The steps of detecting fraud related to home health care services are analogous to the steps in the process of FIGS. 5A-5C or FIGS. 6A-6C.

What is claimed is:

1. A computer-implemented method of detecting a fraudulent health care claim for a payment for a health care service, said method comprising:
generating, by a first computing unit controlled by a health care claim verification entity (CVE), an encrypted bar code (bar code) that includes a set of bar code data that identifies a health care transaction (transaction), wherein said bar code data includes a service date and an identification code (provider ID) of a health care service provider (provider) that provides a health care service (service) to a client on said service date;
receiving, by said first computing unit and subsequent to said generating said bar code, a digital image file that includes said bar code, a set of transaction data that describes said transaction, and a signature that is initially handwritten by said client;
extracting, by said first computing unit and subsequent to said receiving said digital image file, said set of transaction data and said signature from said digital image file;
extracting, by said first computing unit and subsequent to said receiving said digital image file, said provider ID and said service date from said bar code included in said digital image file;
determining, by said first computing unit and subsequent to said extracting said set of transaction data and said signature, that said extracted signature matches a reference signature that is stored in a database that associates said reference signature with said client;
determining that a group of extracted data is not included in any transaction record of a plurality of transaction records stored in said database prior to said generating said bar code, wherein said group of extracted data includes said extracted service date, said extracted provider ID, and an identifier of said client, wherein said identifier of said client is included in said extracted set of transaction data; and
generating, by said first computing unit and in response to said determining that said group of extracted data is not included in any transaction record, a report that identifies a fraudulent health care claim that indicates a billing for said service that is provided by said provider to said client on said service date but that is not authorized by a payer entity via a transaction record being included in said plurality of transaction records stored in said database.

2. The method of claim 1, further comprising:
printing, by a second computing unit controlled by said provider, subsequent to said generating said bar code, and prior to said receiving said digital image file, a transaction document that includes said bar code, a plurality of data entry areas, and a signature entry area, wherein said transaction document is a paper-based artifact;
receiving, subsequent to said printing, said set of transaction data in said plurality of data entry areas included in said transaction document; and
receiving, subsequent to said printing, said signature in said signature entry area.

3. The method of claim 2, wherein said receiving said signature includes receiving said signature as a signature handwritten by said client in said signature entry area, and wherein said method further comprises faxing, subsequent to said receiving said set of transaction data, subsequent to said receiving said signature and prior to said receiving said digital image file, said transaction document to said first computing unit controlled by said CVE.

4. The method of claim 2, wherein said receiving said signature includes receiving said signature as a signature handwritten by said client in said signature entry area, and wherein said method further comprises scanning, subsequent to said receiving said set of transaction data, subsequent to said receiving said signature and prior to said receiving said digital image file, said transaction document, wherein said scanning includes generating said digital image file.

5. The method of claim 2, wherein said receiving said set of transaction data in said plurality of data entry areas includes receiving a plurality of marks in a plurality of optical mark recognition areas included in said plurality of data entry areas, wherein said plurality of marks indicates a portion of an identification of said client.

6. The method of claim 5, wherein said portion of said identification of said client is a portion of a home phone number of said client.

7. The method of claim 2, wherein said receiving said set of transaction data in said plurality of data entry areas includes receiving a plurality of entries in a plurality of optical character recognition (OCR) fields included in said plurality of data entry areas, wherein said plurality of entries indicates a portion of an identification of said client, a pickup time and a drop-off time.

8. The method of claim 7, wherein said portion of said identification of said client is a portion of a name of said client.

9. The method of claim 2, wherein said service is non-emergency medical transportation that includes a plurality of trips, wherein said bar code data further includes one or more identifications of one or more trips of said plurality of trips, and wherein said one or more trips are associated with one or more signature areas on said transaction document in a one-to-one correspondence.

10. The method of claim 1, further comprising:
generating, by said first computing unit, a second encrypted bar code (second bar code) that includes a second set of bar code data that identifies a second health care transaction (second transaction), wherein said second set of bar code data includes a second service date and a second identification code (second provider ID) of a second health care service provider (second provider) that provides a second health care service (second service) to a second client on said second service date, wherein said generating said second bar code includes inserting a unique code in said second bar code;
receiving, by said first computing unit and subsequent to said generating said second bar code, a second digital image file that includes said second bar code, a second set of transaction data that describes said second transaction, and a second signature that is initially handwritten by said second client, wherein said receiving said second digital file includes receiving a digitized version of a transaction document printed by a second computing unit controlled by said second provider, and wherein said unique code uniquely identifies said transaction document;
extracting, by said first computing unit and subsequent to said receiving said second digital image file, said second set of transaction data and said second signature from said second digital image file;
extracting, by said first computing unit and subsequent to said receiving said second digital image file, said second provider ID, said second service date and said unique code from said second bar code included in said second digital image file;
determining, by said first computing unit and subsequent to said extracting said second set of transaction data and said second signature, that said extracted second signature matches a second reference signature that is stored in said database that associates said second reference signature with said second client;
determining, by said first computing unit and subsequent to said determining that said extracted second signature matches said second reference signature, that a second group of extracted data is included in a second transaction record of said plurality of transaction records, wherein said second group of extracted data includes said extracted second service date, said extracted second provider ID, and an identifier of said second client, wherein said identifier of said second client is included in said extracted second set of transaction data;
determining, by said first computing unit and subsequent to said determining that said extracted second signature matches said second reference signature, that said extracted unique code matches a unique code included in said second transaction record; and
generating, by said first computing unit and in response to said determining that said extracted unique code matches said unique code included in said second transaction record, a second report that identifies a fraudulent health care claim that indicates an attempt to bill twice for said second service.

11. The method of claim 1, wherein said extracting said set of transaction data includes automatically extracting, by said first computing unit, said identifier of said client from said set of transaction data, and wherein said determining that said group of extracted data is not included in any transaction record includes:
automatically searching said database, by said first computing unit, for a matching transaction record of said plurality of transaction records, wherein said matching transaction record includes a client identifier that matches said extracted identifier of said client, a date that matches said extracted service date, and a provider identifier that matches said extracted provider ID; and
automatically identifying, by said first computing unit and in response to said automatically searching, that said matching transaction record is absent from said database.

12. The method of claim 11, wherein said determining that said group of extracted data is not included in any transaction record further includes a second computing unit controlled by said payer entity not providing said matching transaction record to said first computing unit, wherein said not providing said matching transaction record to said first computing unit includes said payer entity not authorizing said service to be provided to said client on said service date.

13. The method of claim 1, further comprising automatically denying, by said first computing unit, a payment for said service in response to said determining that said group of extracted data is not included in any transaction record.

14. The method of claim 13, wherein said automatically denying said payment includes:
receiving, by said first computing unit and from a second computing unit controlled by said payer entity, an authorization number that authorizes said payment for said service;
displaying, to said provider via a website controlled by said CVE, a portion of said authorization number; and
preventing, by said first computing unit, said provider from viewing said authorization number in response to said determining that said group of extracted data is not included in any transaction record.

15. The method of claim 14, wherein said authorization number is a Medicaid prior authorization number.

16. The method of claim 1, wherein said determining that said extracted signature matches said reference signature includes:
matching, by said first computing unit, said identifier of said client included in said extracted set of transaction data to a client identifier stored in said database, wherein said database associates said client identifier with one or more reference signatures of said client, and wherein said one or more reference signatures are stored in said database;
retrieving, by said first computing unit and subsequent to said matching said identifier of said client, said one or more reference signatures from said database, wherein said reference signature is included in said one or more reference signatures;
determining, by said first computing unit and subsequent to said retrieving said one or more reference signatures, one or more scores associated with said one or more reference signatures in a one-to-one correspondence, wherein each score indicates a match or a non-match between said extracted signature and one reference signature of said one or more reference signatures based on a set of predefined criteria; and
determining, by said first computing unit and subsequent to said determining said one or more scores, that a score of said one or more scores indicates that said extracted signature matches said reference signature based on said set of predefined criteria.

17. The method of claim 1, further comprising receiving, by said first computing unit, from a second computing unit controlled by an entity other than said CVE, and prior to said generating said bar code, said plurality of transaction records, wherein said entity other than said CVE is an entity that manages a plurality of requests for a plurality of health care services, wherein said plurality of requests includes a request for said service, and wherein said plurality of health care services includes said service.

18. The method of claim 1, wherein said generating said reports includes:
storing, by said first computing unit, said report in said database;
posting, by said first computing unit, said report to a website; and
sending, to a second computing unit controlled by said payer entity or by said provider and subsequent to said posting, said report via said website.

19. The method of claim 1, wherein said service is non-emergency medical transportation, and wherein said provider is a provider of non-emergency medical transportation.

20. The method of claim 1, wherein said service is an act of filling a prescription for said client at a pharmacy, wherein said provider is said pharmacy, and wherein said receiving said digital image file includes receiving a fax of a paper-based transaction document that includes said bar code, a plurality of data entry areas that include said set of transaction data, and a signature entry area that includes said signature.

21. The method of claim 1, wherein said service is an act of rendering health care to said client at an office of a physician, wherein said provider is said physician or another health care provider at said office of said physician, and wherein said receiving said digital image file includes receiving a fax of a paper-based transaction document that includes said bar code, a plurality of data entry areas that include said set of transaction data, and a signature entry area that includes said signature.

22. The method of claim 1, further comprising:
printing, by a second computing unit controlled by said provider, subsequent to said generating said bar code, and prior to said receiving said digital image file, a transaction document that includes said bar code and a plurality of data entry areas;
receiving said signature as a biometric signature provided by said client on a digitizing tablet controlled by said provider; and
generating said digital image file, wherein said generating said digital image file includes incorporating said biometric signature in said digital image file.

23. The method of claim 1, further comprising:
generating, by said first computing unit, a second encrypted bar code (second bar code) that includes a second set of bar code data that identifies a second health care transaction (second transaction), wherein said second set of bar code data includes a second service date and a second identification code (second provider ID) of a second health care service provider (second provider) that provides a second health care service (second service) to a second client on said second service date;
receiving, by said first computing unit and subsequent to said generating said second bar code, a second digital image file that includes said second bar code, a second set of transaction data that describes said second transaction, and a second signature that is initially handwritten by said second client;
extracting, by said first computing unit and subsequent to said receiving said second digital image file, said second set of transaction data and said second signature from said second digital image file;
extracting, by said first computing unit and subsequent to said receiving said second digital image file, said second provider ID and said second service date from said second bar code included in said second digital image file;
determining, by said first computing unit and subsequent to said extracting said second set of transaction data and said second signature, that said extracted second signature does not match any reference signature in a second set of one or more reference signatures that are associated with said second client in said database; and
generating, by said first computing unit and in response to said determining that said extracted second signature does not match any reference signature, a second report that identifies a fraudulent health care claim that indicates a billing for said second service, but said second service is not provided to said second client by said second provider on said second service date.

24. A computing system comprising a processor coupled to a computer-readable memory unit, said memory unit comprising a software application, said software application comprising instructions that when executed by said processor implement the method of claim 1.

25. A computer program product, comprising a computer-usable medium having a computer-readable program code embodied therein, said computer-readable program code comprising an algorithm adapted to implement the method of claim 1.

26. A computer-implemented method of detecting a fraudulent health care claim for a payment for a health care service, said method comprising:
generating, by a first computing unit controlled by a health care claim verification entity (CVE), an encrypted bar code that includes a set of bar code data that identifies a plurality of health care transactions (transactions), wherein said bar code data includes a service date and an identification code (provider ID) of a health care service provider (provider) that is requested to provide a plurality of health care services to a plurality of clients on said service date, wherein said plurality of transactions includes a transaction that indicates that said provider is requested to provide, on said service date, a health care service (service) of said plurality of health care services to a client of said plurality of clients;
storing, by said first computing unit and subsequent to said generating said bar code, said bar code in a computer data file;
posting, by said first computing unit and subsequent to said storing said bar code, said computer data file to a website controlled by said CVE and accessible by a second computing unit controlled by said provider;
sending said computer data file that stores said bar code to said second computing unit via an access of said website by said second computing unit;
printing, by said second computing unit and subsequent to said sending said computer data file that stores said bar code, a transaction document that includes said bar code and a plurality of data entry areas for receiving a set of transaction data that describes said transaction;
receiving, by said first computing unit and subsequent to said printing, a digital image file that includes said bar code data, said set of transaction data received in said plurality of data entry areas and a signature that indicates said client;
extracting, by said first computing unit and subsequent to said receiving said digital image file, said bar code data, said signature, and said set of transaction data from said digital image file;
determining, by a signature verification engine executing on said first computing unit and subsequent to said extracting, a score that indicates whether said extracted signature matches a reference signature that is stored in a database residing in a computer data storage unit, wherein said database associates said reference signature with said client;
generating, by said first computing unit and if said score does not satisfy a set of predefined criteria for matching said extracted signature to said reference signature, a first report that includes a first type of said fraudulent health care claim, wherein said first type indicates a billing for said service by said provider, but said service is not provided to said client by said provider;
searching said database, by said first computing unit and subsequent to said extracting, for a match between a group of extracted data and a transaction record of a plurality of transaction records stored in said database prior to said generating said bar code, wherein said group of extracted data includes said extracted set of transaction data and said extracted bar code data, wherein said match includes an identifier of said client included in said extracted set of transaction data matching a client identifier in said transaction record, said extracted service date included in said extracted bar code data matching a date in said transaction record, and said extracted provider ID included in said extracted bar code data matching a provider identifier in said transaction record;
identifying, in response to said searching, that said match is absent; and
generating, by said first computing unit and in response to said identifying, a second report that includes a second type of said fraudulent health care claim, wherein said second type indicates a billing for said service, but said service provided by said provider to said client on said service date is not authorized by any transaction record of said plurality of transaction records.

27. A computer-implemented method of verifying a claim for a payment for a health care service, said method comprising:
generating, by a first computing unit controlled by a health care claim verification entity (CVE), an encrypted bar code (bar code) that includes a set of bar code data that identifies a health care transaction (transaction), wherein said bar code data includes a service date and an identification code (provider ID) of a health care service provider (provider) that provides a health care service (service) to a client on said service date;
receiving, by said first computing unit and subsequent to said generating said bar code, a digital image file that includes said bar code, a set of transaction data that describes said transaction, and a signature that is initially handwritten by said client;
extracting, by said first computing unit and subsequent to said receiving said digital image file, said set of transaction data and said signature from said digital image file;
extracting, by said first computing unit and subsequent to said receiving said digital image file, said provider ID and said service date from said bar code included in said digital image file;
determining, by said first computing unit and subsequent to said extracting said set of transaction data and said signature, that said extracted signature matches a reference signature that is stored in a database that associates said reference signature with said client;
determining that a group of extracted data is included in a transaction record of a plurality of transaction records stored in said database prior to said generating said bar code, wherein said group of extracted data includes said extracted service date, said extracted provider ID, and an identifier of said client, wherein said identifier of said client is included in said extracted set of transaction data; and
generating, by said first computing unit, in response to said determining that said group of extracted data is included in said transaction record and in response to said determining that said extracted signature matches said reference signature, a report that verifies a claim for a payment of said service.

28. The method of claim 27, wherein said determining that said group of extracted data is included in said transaction record includes:
automatically filtering out, by said first computing unit, a first set of one or more transaction records from said plurality of transaction records, wherein each transaction record of said first set of one or more transaction records includes a client identifier that does not match said identifier of said client that is included in said extracted set of transaction data;
automatically filtering out, by said first computing unit, a second set of one or more transaction records from said plurality of transaction records, wherein each transaction record of said second set of one or more transaction records includes a client identifier that matches said identifier of said client that is included in said extracted set of transaction data and further includes a provider identifier that does not match said extracted provider ID, and wherein said provider identifier included in said second set of one or more transaction records identifies a provider that is requested to provide said service to said client;
automatically filtering out, by said first computing unit, a third set of one or more transaction records from said plurality of transaction records, wherein each transaction record of said third set of one or more transaction records includes said client identifier that matches said identifier of said client that is included in said extracted set of transaction data and further includes a date that does not match said extracted service date, wherein said date included in said third set of one or more transaction records is a date of said service to be provided to said client;
displaying, by said first computing unit, and in response to said automatically filtering out said first set, said automatically filtering out said second set, and said automatically filtering out said third set, a list of one or more transaction records, wherein said list does not include said first set of one or more transaction records, said second set of one or more transaction records and said third set of one or more transaction records; and
identifying, subsequent to said displaying said list, said transaction record in said list of one or more transaction records.
